(19) United States
(12) Patent Application Publication
(10) Pub. No.: US 2014/0347297 A1
(43) Pub. Date: Nov. 27, 2014

(54) SEMICONDUCTOR DEVICE AND DISPLAY DEVICE

(71) Applicant: Renesas SP Drivers Inc., Tokyo (JP)

(72) Inventor: Sosuke Tsuji, Kodaira (JP)

(73) Assignee: Renesas SP Drivers Inc., Tokyo (JP)

(21) Appl. No.: 14/283,241

(22) Filed: May 21, 2014

(30) Foreign Application Priority Data
May 23, 2013 (JP) 2013-108896

(51) Int. Cl. G06F 3/041

(52) U.S. Cl. CPC G06F 3/041
USPC 345/173

(57) ABSTRACT

The semiconductor device includes: a display panel (e.g. a liquid crystal display panel) which has a capacitor for holding an electric charge corresponding to image data in quantity in each pixel and displays image data of each frame made up of lines; and a display-drive circuit for activating the display panel. The display-drive circuit performs a time-division action in which a one-frame period includes display-drive periods in which the display panel is activated, and blank periods in which the activation of the display panel remains stopped, which are arranged alternately. The display-drive circuit drives, for display, lines of one frame which are almost evenly distributed to display-drive periods in groups of several lines.

### CROSS-REFERENCE TO RELATED APPLICATIONS

The Present application claims priority from Japanese application JP 2013-108896 filed on May 23, 2013, the content of which is hereby incorporated by reference into this application.

### BACKGROUND

The present invention relates to a display driver IC (Integrated Circuit) of a display panel with a touch sensor, LSI (Large Scale Integrated circuit) having a display driver and a touch-control circuit integrated therein, and a display device having the display panel and LSI mounted therein, which can be suitably used for especially preventing the degradation of image quality.

In regard to display devices, On-cell model in which a display panel and a touch panel are independently provided of each other was mainstream in the past, whereas in recent years In-cell model in which a display panel and a touch panel are integrated into one body, and which enables further slimming down of panel modules, especially mobile type ones is becoming widespread. With On-cell model, a display panel and a touch sensor are independent of each other and therefore, the Separate chip design by which a display driver and a touch controller are independently formed in separate chips makes a mainstream. As to the Separate chip design, it is common to put the display driving and the sensing into action asynchronously. On the other hand, in the case of In-cell model, the display driving and the sensing are not performed concurrently for suppressing the noise at sensing; the means for alternately putting the display driving and the sensing into action according to the time-division technique has been proposed instead.

A display device of In-cell model which alternately operates a touch sensor and display elements according to the time-division technique, and a method for activation of the display device have been disclosed in JP-A-2012-059265. In the display device, the sensing by the touch sensor, and the driving of the display elements are alternately performed according to the time-division technique. In In-cell model, one frame is divided into a display mode and a touch-sensing mode, and a timing controller controls a gate driver, a source driver and a touch controller so that these modes are executed alternately. In this model, a high level of touch detection accuracy is achieved because an image is displayed in groups of a plurality of lines intermittently, and the touch sensing is performed in a period during which the image output from the display driver remains stopped. Hence, the noise of a signal used to drive each display element never mixes into a detection signal of the touch sensor, and the influence of the noise can be reduced.

### SUMMARY

After the consideration on JP-A-2012-059265, the inventor found new problems as described below.

For instance, in the case of using a display panel, such as a liquid crystal display panel arranged so that an electric charge corresponding to image data to be displayed in quantity is held by a capacitor in each pixel to alternately perform the sensing action by a touch sensor, and the action of driving display elements according to the time-division technique as described in JP-A-2012-059265, a step consisting of a sharp change in brightness is formed in a boundary portion of regions which are different in display-drive period and in which the brightness should be changed smoothly in essence, which causes the problem of the degradation in image quality.

In a liquid crystal display panel, for example, an electric charge corresponding to image data to be displayed in quantity is charged into a capacitor in each pixel sequentially; and the brightness in display is controlled by controlling a quantity of polarization of light by liquid crystal by means of potential differences produced according to electric charges held by the capacitors. The electric charge held by each capacitor gradually decreases with time owing to leakage and in parallel with this, the brightness in display is also varied. In case that the brightness is uniformly changed in an entire image frame, it is difficult to recognize the change with the human eye. With a step of brightness located halfway in a region in which the brightness should be changed smoothly in essence, the human eye will wind up recognizing the step on condition that the step runs linearly and uninterruptedly at a boundary between regions even if the step is not large.

For instance, supposing that a sensing period is provided subsequently to the display of the upper half of one frame, and thereafter the lower half of the frame is displayed, an electric charge held by the capacitor of each pixel in the region of the upper half of the frame is uniformly further reduced in comparison to an electric charge held by the capacitor of each pixel in the lower half region owing to the leakage for a longer time by the length of the sensing period. As a result, the difference in the quantity of decrease of the electric charge owing to the leakage is uniformly produced at the boundary of the upper half region and the lower half region. The difference in the quantity of decrease of the electric charge makes the difference in brightness on the boundary line, which winds up being recognized with the human eye.

In case that such difference in brightness is large enough to visually recognize, the quality of an image is degraded.

While the above description has been made taking a liquid crystal display panel as an example, the problem as described above can arise commonly to display devices which use a display panel arranged so that an electric charge corresponding to image data to be displayed in quantity is held by a capacitor in each pixel to intermittently drive display elements for each region.

The means for solving the problem will be described below. The other problem and novel features will become apparent from the description hereof and the accompanying drawings.

According to an embodiment of the invention, the means for solving the problem is as follows.

That is, a semiconductor device including a display-drive circuit for activating a display panel which has a capacitor for holding an electric charge corresponding to image data in quantity in each pixel and displays image data of each frame made up of a plurality of lines, or a display device including the display-drive circuit, which is arranged as described below.

The display-drive circuit works according to a time-division technique, in which one frame period includes more than one display-drive period during which the display panel remains activated and more than one blank period during which the activation of the display panel remains stopped; the display-drive and blank periods are alternated with each other. The display-drive circuit drives, for display, the lines in one frame which are almost evenly distributed to the display-drive periods in groups of several lines.

The effect which the above embodiment brings about will be briefly described below.

The boundaries between regions produced by the difference in brightness resulting from time-division display can be made harder to visually recognize, and the degradation of display image quality which would result from time-division display can be prevented.

### BRIEF DESCRIPTION OF THE DRAWINGS

FIG. 1 is a block diagram showing an example of the configuration of a display device according to the invention;

FIG. 2 is a timing diagram for explaining a display action according to the representative embodiment of the invention;

FIG. 3 is a partially enlarged diagram of the timing diagram shown in FIG. 2;

FIG. 4 is a circuit diagram showing an example of the configuration of an in-panel gate control circuit in the display device;

FIG. 5 is a timing diagram for explaining the action of the in-panel gate control circuit shown in FIG. 4;

FIG. 6 is a timing diagram for explaining the display action according to a first embodiment;

FIG. 7 is a partially enlarged diagram of the timing diagram shown in FIG. 6;

FIG. 8 is a circuit diagram showing an example of the configuration of the in-panel gate control circuit in the display device according to the first embodiment;

FIG. 9 is a timing diagram for explaining the action of the in-panel gate control circuit shown in FIG. 8;

FIG. 10 is a circuit diagram showing an example of the configuration of the in-panel gate control circuit in a display device according to a second embodiment;

FIG. 11 is a timing diagram for explaining the display action according to a third embodiment;

FIG. 12 is a timing diagram for explaining the action of the in-panel gate control circuit in a display device according to the third embodiment;

FIG. 13 is an explanatory diagram showing an example of image display by a conventional time-division action;

FIG. 14 is an explanatory diagram showing an example of image display by time-division actions by the display device according to the invention;

FIG. 15 is a block diagram showing an example of the configuration of a display device according to a fourth embodiment;

FIG. 16 is a circuit diagram showing an example of the configuration of a pair of in-panel gate control circuits in a display device according to the fourth embodiment;

FIG. 17 is a timing diagram for explaining the action of the pair of in-panel gate control circuits shown in FIG. 16;

FIG. 18 is a timing diagram for explaining the display action according to the fourth embodiment; and

FIG. 19 is an explanatory diagram showing an example of image display by the time-division action of the display device according to the fourth embodiment.

### DETAILED DESCRIPTION

### 1. Summary of the Embodiments

First, summary of representative embodiments of the invention disclosed in the application will be described. Reference numerals in drawings in parentheses referred to in description of the summary of the representative embodiments just denote components included in the concept of the components to which the reference numerals are designated.

[1]<Display-Drive Circuit which Performs a Display Action with Groups of the Lines Evenly Distributed to Display-Drive Periods

The semiconductor device (2 or 3) including a display-drive circuit (3) operable to output drive signals for activating for a display panel (5) which displays image data of each frame made up of a plurality of lines is arranged as described below.

The display panel has a capacitor for holding an electric charge corresponding, in quantity, to the image data in each of pixels constituting the lines.

The display-drive circuit is arranged to be able to work according to a time-division technique, in which one frame period (the time t0 to t6) includes a first display-drive period (the time t0 to t1), a first blank period (the time t1 to t2), and a second display-drive period (the time t2 to t3) in sequence.

The display-drive circuit is arranged to be able to output the drive signals, and it drives the lines (31) in one frame of the display panel distributed in a predetermined cycle in the first display-drive period, stops activating the display panel in the first blank period, and drives, in the second display-drive period, lines (32) of the display panel different from the lines driven for display in the first display-drive period in the one frame.

In this way, it becomes possible to provide a semiconductor device having a display-drive circuit for activating a display panel which is arranged so as to make the boundaries between regions produced by the difference in brightness resulting from time-division display harder to visually recognize and to prevent the degradation of display image quality which would result from time-division display.

[2]<Time-Division Action for Display and Sensing in a Touch Panel-Integrated Display Device>

The semiconductor device as described in [1] further includes: a touch panel controller (4) operable to sense a touch state of a touch panel (6) layered on the display panel. The semiconductor device is arranged as follows.

The touch panel controller performs a touch-state-sensing action for sensing the touch state in the first blank period, and stops the touch-state-sensing action in the first and second display-drive periods.

According to the embodiment like this, it is possible to provide a semiconductor device by which the detection accuracy in the touch-detecting action can be increased without causing the degradation of display image quality which would result from time-division display even in a display device having a display panel with a touch panel integrally laminated therewith. The first blank period, and a period for performing the touch-state-sensing action which is included therein may overlap with one or both of the first and second display-drive periods in terms of time. The signal-to-noise ratio (S/N ratio) in the touch-detecting action is increased by reducing the overlap in terms of time, and the best S/N ratio is achieved by reducing the overlap in terms of time. The detection accuracy can be raised by increase in the S/N ratio. In contrast, a longer time can be taken for the touch-detecting action by allowing such temporal overlap and consequently, the detection accuracy can be increased in some cases.

[3]<Distribution in Groups of N Lines with M-Line Cycle>

In the semiconductor device as described in [1] or [2], the display-drive circuit is arranged to be able to output the drive signals for: driving, in the first display-drive period, lines of the display panel distributed in groups of N lines (N is an integer equal to or larger than one) with an M-line cycle (M is an integer equal to or larger than one) in one frame; and driving, in the second display-drive period, lines of the display panel different from the lines driven for display in the first display-drive period in the one frame, and distributed in groups of N lines with the M-line cycle in the one frame.

According to the embodiment like this, it becomes possible to provide a semiconductor device having a display-drive circuit which is arranged so that the boundaries between regions different in display-drive period are almost evenly dispersed, and thus the boundaries between regions which are produced by the difference in brightness resulting from time-division display are made harder to visually recognize and in addition, the degradation of display image quality which would result from time-division display can be prevented in a display panel connected thereto. For instance, regions different in display-drive period are evenly distributed in the time-division action in which the predetermined cycle is made an M-line cycle, and one frame period is divided into M/N display-drive periods, and M/N, M/N+1, or M/N−1 blank periods.

### [4]<Distribution in Lines (N=1) >

In the semiconductor device as described in [3], the display-drive circuit is arranged to be able to output the drive signals for: driving, in the first display-drive period, lines of the display panel distributed in lines with the M-line cycle in one frame; and driving, in the second display-drive period, lines of the display panel different from the lines driven for display in the first display-drive period in the one frame, and distributed in lines with the M-line cycle in the frame.

According to the embodiment like this, it becomes possible to provide a semiconductor device having a display-drive circuit which is arranged so that the regions different in display-drive period are minutely and evenly distributed, and thus the boundaries between regions which are produced by the difference in brightness resulting from time-division display are made harder to visually recognize and in addition, the degradation of display image quality which would result from time-division display can be prevented in a display panel connected thereto. For instance, regions different in display-drive period are evenly distributed in one frame by the time-division action, in which the predetermined cycle is an M-line cycle, and a one-frame period is divided into M display-drive periods, and M, M+1, or M−1 blank periods.

[5]<Alternating Distribution in Lines>

In the semiconductor device as described in [4], the display-drive circuit is arranged to be able to output the drive signals for: driving, in the first display-drive period, lines of the display panel distributed in lines with a 2-line cycle in one frame; and driving, in the second display-drive period, other lines different from the lines driven for display in the first display-drive period in the one frame.

According to the embodiment like this, it becomes possible to provide a semiconductor device having a display-drive circuit which is arranged so that the regions different in display-drive period are minutely and evenly distributed, and thus the boundaries between regions which are produced by the difference in brightness resulting from time-division display are made harder to visually recognize and in addition, the degradation of display image quality which would result from time-division display can be prevented in a display panel connected thereto. For instance, in the time-division action in which two display-drive periods are included in one frame, the regions different in display-drive period are minutely and evenly distributed by displaying odd-numbered lines in one of the display-drive periods, and even-numbered lines in the other display-drive period.

[6]<Change in the Order of Display of Regions to be Displayed Between Successive Frames>

In the semiconductor device as described in [3], the display-drive circuit is arranged to be able to output the drive signals for performing the action including the following steps.

The step of driving lines of the display panel distributed in groups of N lines (N is an integer equal to or larger than one) with an M-line cycle (M is an integer equal to or larger than one) in a first frame in a first display-drive period of the first frame; The step of driving, in a second display-drive period of the first frame, lines of the display panel different from the lines driven for display in the first display-drive period, and distributed in groups of N lines with the M-line cycle in the first frame; and the step of driving, in a first display-drive period of a second frame subsequent to the first frame, lines of the display panel different from the lines driven for display in the first display-drive period of the first frame, and distributed in groups of N lines with the M-line cycle in the second frame.

According to the embodiment like this, it becomes possible to provide a semiconductor device having a display-drive circuit which is arranged so that the boundaries between regions different in display-drive period are evenly dispersed also in the time axis direction, and thus the boundaries between regions which are produced by the difference in brightness resulting from time-division display are made harder to visually recognize and in addition, the degradation of display image quality which would result from time-division display can be prevented in a display panel connected thereto.

[7]<Alternating Display of Odd-Numbered Lines and Even-Numbered Lines in Successive Frames>

In the semiconductor device as described in [6], the display-drive circuit is arranged to be able to output the drive signals for performing the action including the following steps.

The step of driving odd-numbered lines in the first frame in a first display-drive period of a first frame, the step of driving even-numbered lines in the first frame in a second display-drive period of the first frame; the step of driving even-numbered lines in the second frame subsequent to the first frame in a first display-drive period of the second frame; and the step of driving odd-numbered lines in the second frame in a second display-drive period of the second frame.

According to the embodiment like this, it becomes possible to provide a semiconductor device having a display-drive circuit which is arranged so that a display-drive period in which odd-numbered lines are driven for display and a display-drive period in which even-numbered lines are driven for display are alternated between the first and second display-drive periods for each frame, the boundaries between regions which are produced by the difference in brightness resulting from time-division display can be made harder to visually recognize even if the performance of a pixel keeping electric charge varies from pixel to pixel, and the degradation of display image quality which would result from time-division display can be prevented in a display panel connected therewith.

[8]<Frame Memory for Interlace>

In the semiconductor device as described in one of [1] to [7], the display-drive circuit includes a memory (14), and a control part (13).

The control part writes, into the memory, image data which are input in an order of lines of a frame to be displayed going through a sequential scan from its top line, and reads out, in the first display-drive period, image data of lines to be displayed in the first display-drive period from the memory in an order to drive the lines for display in. Further, the control part reads out, in the second display-drive period, image data of lines to be displayed in the second display-drive period from the memory.

The display-drive circuit produces the drive signals based on the read image data.

According to the embodiment like this, even if image data taken by the conventional raster scan (sequential scan) method are input just in the order of the image being scanned, the display-drive circuit 3 can appropriately permutate the scan, and then output drive signals to the display panel. It is preferable that the memory has a memory capacity enough to store image data of at least one frame. This is because image data of one frame are input to the memory and after that, the image data are read out therefrom for each line to be displayed with a predetermined cycle.

[9]<Timing Signal to the Touch Panel Controller>

In the semiconductor device as described in [2], the display-drive circuit includes a memory (14) and a control part (13).

The control part writes, into the memory, image data which are input in an order of lines of a frame to be displayed going through a sequential scan from its top line, and reads out, in the first display-drive period, image data of lines to be displayed in the first display-drive period from the memory in an order to drive the lines for display in. Further, the control part reads out, in the second display-drive period, image data of lines to be displayed in the second display-drive period from the memory.

The display-drive circuit produces the drive signals based on the read image data.

The control part outputs timing signals to the touch panel controller.

The touch panel controller controls start and stop of the touch-state-sensing action in the first blank period and the first and second display-drive periods based on the timing signals.

According to the embodiment like this, even if image data taken by the conventional raster scan (sequential scan) method are input just in the order of the image being scanned, the display-drive circuit 3 can appropriately permutate the scan, and then output drive signals to the display panel. Further, the action of driving for display, and the touch-state-detecting action can be synchronized with each other.

[10]<Integration of the Display-Drive Circuit and the Touch Panel Controller>

In the semiconductor device as described in [2] or [9], the display-drive circuit and the touch panel controller are integrated together on a semiconductor substrate.

According to the embodiment like this, the number of parts or components can be reduced, and the mounting area on the substrate can be reduced. Other than the display-drive circuit and the touch panel controller, a circuit, e.g. MPU may be further integrated on the same semiconductor substrate.

[11]<Storing Compressed Image Data in the Memory>

In the semiconductor device as described in [8], the display-drive circuit further includes a compression circuit (33), and a decompression circuit (34).

The control part causes the compression circuit to perform data compression of image data which are input in an order of lines of a frame to be displayed going through a sequential scan from its top line, and then writes the compressed data into the memory. The control part reads out, in the first display-drive period, compressed data including image data of lines to be displayed in the first display-drive period from the memory in an order to drive the lines for display in, and reads out, in the second display-drive period, compressed data including image data of lines to be displayed in the second display-drive period from the memory.

The decompression circuit restores image data of the lines to be displayed by decompressing the compressed data read out from the memory.

The display-drive circuit produces the drive signals based on the image data thus restored.

According to the embodiment like this, it is possible to keep the capacity of the memory (14) down.

[12]<Agreement Between the Number of Lines Forming a Unit of Data Compression and the Number of Lines Forming a Unit of Distribution Display>

In the semiconductor device as described in [11], the display-drive circuit is arranged to be able to output the drive signals for: driving, in the first display-drive period, lines of the display panel distributed in groups of N lines (N is an integer equal to or larger than one) with an M-line cycle (M is an integer equal to or larger than one) in one frame; and driving, in the second display-drive period, lines of the display panel different from the lines driven for display in the first display-drive period in the one frame, and distributed in groups of N lines with the M-line cycle in the one frame.

The compression circuit executes the data compression on image data in groups of N lines, and the decompression circuit restores image data by decompressing data subjected to the data compression in groups of N lines.

According to the embodiment like this, the compression circuit (33) and the decompression circuit (34) can be operated efficiently. In addition, the number of lines forming a unit of data compression is made N, and the driving for display is performed in the same units, i.e. in groups of N lines. In other words, N lines of image data to be displayed are collectively compressed and stored, and collectively decompressed as a unit of image compression and decompression. As a result, the decompressed image data agree with displayed image data, and no waste is caused in decompressed image data.

[13]<Display Device which Displays Lines by Means of Evenly Distributing the Lines to Display-Drive Periods>

A display device includes a display panel (5) operable to display image data of each frame made up of a plurality of lines, and a display-drive circuit (3) operable to output a drive signal for activating the display panel, and arranged as follows.

The display panel has, in each pixel of pixels constituting the lines, a capacitor for holding an electric charge corresponding to the image data in quantity.

The display-drive circuit is arranged to be able to work according to a time-division technique, in which one frame period (the time t0 to t6) includes a first display-drive period (the time t0 to t1), a first blank period (the time t1 to t2), and a second display-drive period (the time t2 to t3) in sequence.

The display-drive circuit drives lines (31) of the display panel distributed with a predetermined cycle in one frame in the first display-drive period, stops activating the display panel in the first blank period, and drives, in the second display-drive period, lines (32) of the display panel different from the lines driven for display in the first display-drive period in the one frame.

According to the embodiment like this, the boundaries between regions produced by the difference in brightness resulting from time-division display can be made harder to visually recognize, and the degradation of display image quality which would result from time-division display can be prevented.

[14]<Time-Division Action for Display and Sensing in a Touch Panel-Integrated Display Device>

The display device as described in [13] further includes: a touch panel (6) layered on the display panel (5); and a touch panel controller (4) operable to sense a touch state of the touch panel.

The touch panel controller performs a touch-state-sensing action for sensing the touch state in the first blank period, and stops the touch-state-sensing action in the first and second display-drive periods.

According to the embodiment like this, the detection accuracy in the touch-detecting action can be increased without causing the degradation of display image quality which would result from time-division display even with a display device having a display panel with a touch panel integrally laminated therewith. The first blank period, and a period for performing the touch-state-sensing action which is included therein may overlap with one or both of the first and second display-drive periods in terms of time. The signal-to-noise ratio (S/N ratio) in the touch-detecting action is increased by reducing the overlap in terms of time, and the best S/N ratio is achieved by reducing the overlap in terms of time. The detection accuracy can be raised by increase in the S/N ratio. In contrast, a longer time can be taken for the touch-detecting action by allowing such temporal overlap and consequently, the detection accuracy can be increased in some cases.

[15]<Distribution in Groups of N Lines with an M-Line Cycle>

In the display device as described in [13] or [14], the display-drive circuit drives, in the first display-drive period, lines of the display panel distributed in groups of N lines (N is an integer equal to or larger than one) with an M-line cycle (M is an integer equal to or larger than one) in one frame, and drives, in the second display-drive period, lines of the display panel different from the lines driven for display in the first display-drive period in the one frame, and distributed in groups of N lines with the M-line cycle in the frame.

According to the embodiment like this, the boundaries between regions different in display-drive period are almost evenly dispersed, and thus the boundaries between regions which are produced by the difference in brightness resulting from time-division display can be made harder to visually recognize and in addition, the degradation of display image quality which would result from time-division display can be prevented. For instance, regions different in display-drive period are evenly distributed in the time-division action in which the predetermined cycle is made an M-line cycle, and one frame period is divided into M/N display-drive periods, and M/N, M/N+1, or M/N−1 blank periods.

[16]<Distribution in Lines (N=1) >

In the display device as described in [15], the display-drive circuit drives, in the first display-drive period, lines of the display panel distributed in lines with the M-line cycle in one frame, and drives, in the second display-drive period, lines of the display panel different from the lines driven for display in the first display-drive period in the one frame, and distributed in lines with the M-line cycle in the frame.

According to the embodiment like this, the regions different in display-drive period are minutely and evenly distributed, and thus the boundaries between regions which are produced by the difference in brightness resulting from time-division display can be made harder to visually recognize and further, the degradation of display image quality which would result from time-division display can be prevented. For instance, regions different in display-drive period are evenly distributed in the time-division action in which the predetermined cycle is made an M-line cycle, and one frame period is divided into M display-drive periods, and M, M+1, or M−1 blank periods.

[17]<Alternating Distribution in Lines>

In the display device as described in [16], the display-drive circuit drives, in the first display-drive period, lines of the display panel distributed in lines with a 2-line cycle in one frame, and drives, in the second display-drive period, other lines of the display panel different from the lines driven for display in the first display-drive period in the one frame.

According to the embodiment like this, the regions different in display-drive period are minutely and evenly distributed and thus, the boundaries between regions which are produced by the difference in brightness resulting from time-division display can be made harder to visually recognize and further, the degradation of display image quality which would result from time-division display can be prevented. For instance, in the time-division action in which two display-drive periods are included in one frame, the regions different in display-drive period are minutely and evenly distributed by displaying odd-numbered lines in one of the display-drive periods, and even-numbered lines in the other display-drive period.

[18]<Change in the Order of Display of Regions to be Displayed Between Successive Frames>

In the display device as described in [15], the display-drive circuit drives, in a first display-drive period of a first frame, lines of the display panel distributed in groups of N lines (N is an integer equal to or larger than one) with an M-line cycle (M is an integer equal to or larger than one) in the first frame. Further, the display-drive circuit drives, in a second display-drive period of the first frame, lines of the display panel different from the lines driven for display in the first display-drive period, and distributed in groups of N lines with the M-line cycle in the first frame. Still further, the display-drive circuit drives, in a first display-drive period of a second frame subsequent to the first frame, lines of the display panel different from the lines driven for display in the first display-drive period of the first frame, and distributed in groups of N lines with the M-line cycle in the second frame.

According to the embodiment like this, the boundaries between regions different in display-drive period are evenly dispersed also in the time axis direction and thus, the boundaries between regions which are produced by the difference in brightness resulting from time-division display can be made harder to visually recognize and further, the degradation of display image quality which would result from time-division display can be prevented.

[19]<Alternating Display of Odd-Numbered Lines and Even-Numbered Lines in Successive Frames>

In the display device as described in [18], the display-drive circuit drives odd-numbered lines in the first frame in a first display-drive period of a first frame, drives even-numbered lines in the first frame in a second display-drive period of the first frame, drives even-numbered lines in a second frame subsequent to the first frame in a first display-drive period of the second frame, and drives odd-numbered lines in the second frame in a second display-drive period of the second frame.

According to the embodiment like this, a display-drive period in which odd-numbered lines are driven for display and a display-drive period in which even-numbered lines are driven for display are alternated between the first and second display-drive periods for each frame; the boundaries between regions which are produced by the difference in brightness resulting from time-division display can be made harder to visually recognize even if the performance of a pixel keeping electric charge varies from pixel to pixel; and the degradation of display image quality which would result from time-division display can be prevented.

[20]<In-Panel Gate Control Circuit>

In the display device as described in [15], the display-drive circuit supplies display panel with a flag indicating a line to be driven for display, and the display panel includes a shift register (22) having a memory element provided for each group of N lines with the M-line cycle. The shift register accepts input of the flag, and is arranged so that the flag can be shifted by the line.

According to the embodiment like this, the number of signal lines between the display-drive circuit and the display panel can be reduced.

[21]<In-Panel Gate Control Circuit with a Pair of Shift Registers for Distribution in Lines with a 2-Line Cycle>

In the display device as described in [20], the display panel has a pair of shift registers (22_4, 22_5) each having a memory element provided for each line with a 2-line cycle.

According to the embodiment like this, as circuit for distributing a display region in lines with the 2-line cycle, i.e. alternately can be formed readily.

[22]<In-Panel Gate Control Circuit with a Pair of Shift Registers Disposed on Both Sides of the Display Panel>

In the display device as described in [21], the paired shift registers are disposed in regions sandwiching therebetween a display region of the display panel.

According to the embodiment like this, the in-panel gate control circuits can be disposed efficiently. This is because the pitch of gate drivers for driving the gate lines, and the pitch of the memory elements (flip-flops) constituting the shift registers, which are allowable in terms of layout, are enlarged to twice the gate line pitch.

[23]<Compressing and Storing Image Data in the Memory>

In the display device as described in [15], the display-drive circuit includes a compression circuit (33), a memory (14), a decompression circuit (34), and a control part (13).

The control part causes the compression circuit to perform data compression of image data which are input in an order of lines of a frame to be displayed going through a sequential scan from its top line, and then writes the compressed data into the memory. Further, the control part reads out, in the first display-drive period, compressed data including image data of lines to be displayed in the first display-drive period from the memory in an order to drive the lines for display in, and reads out, in the second display-drive period, compressed data including image data of lines to be displayed in the second display-drive period from the memory.

The decompression circuit restores image data of the lines to be displayed by decompressing the compressed data read out from the memory,

The display-drive circuit produces the drive signals based on the image data thus restored.

According to the embodiment like this, even if image data taken by the conventional raster scan (sequential scan) method are input just in the order of the image being scanned, the display-drive circuit 3 can appropriately permutate the scan, and then output drive signals to the display panel. It is preferable that the memory has a memory capacity enough to store image data of at least one frame. This is because image data of one frame are input to the memory and after that, the image data are read out therefrom for each line to be displayed with a predetermined cycle. Since image data are compressed at the time of write into the memory, and decompressed after having been read out therefrom, the capacity of the memory (14) can be kept small.

[24]<Agreement Between the Number of Lines Forming a Unit of Data Compression and the Number of Lines Forming a Unit of Distribution Display>

In the display device as described in [23], the display-drive circuit is arranged to be able to output the drive signals for: driving, in the first display-drive period, lines of the display panel distributed in groups of N lines (N is an integer equal to or larger than one) with an M-line cycle (M is an integer equal to or larger than one) in one frame; and driving, in the second display-drive period, lines of the display panel different from the lines driven for display in the first display-drive period in the one frame, and distributed in groups of N lines with the M-line cycle in the one frame.

The compression circuit executes the compression on image data in groups of N lines, and the decompression circuit restores image data by decompressing data subjected to the data compression in groups of N lines.

According to the embodiment like this, the compression circuit (33) and the decompression circuit (34) can be operated efficiently. In addition, the number of lines forming a unit of data compression is made N, and the driving for display is performed in the same units, i.e. in groups of N lines. In other words, N lines of image data to be displayed are collectively compressed and stored, and collectively decompressed as a unit of image compression and decompression. As a result, the decompressed image data agree with displayed image data, and no waste is caused in decompressed image data.

[25]<In-Panel Gate Control Circuit with a Shift Register for Distribution in Groups of N Lines>

In the display device as described in [24], the display-drive circuit supplies display panel with a flag indicating a line to be driven for display; the display panel includes a shift register having a memory element provided for each group of N lines with the M-line cycle; and the shift register accepts input of the flag, and is arranged so that the flag can be shifted by the line.

According to the embodiment like this, the number of signal lines between the display-drive circuit and the display panel can be decreased. In addition, a circuit for distributing a display region in groups of N lines, i.e. in groups of a number of lines which is the unit of image compression with an M-line cycle can be configured readily.

### 2. Further Detailed Description of the Embodiments

The embodiments will be described further in detail.

### Representative Embodiment

### Display Device which Offers a Display with Lines Evenly Distributed to Display-Drive Periods

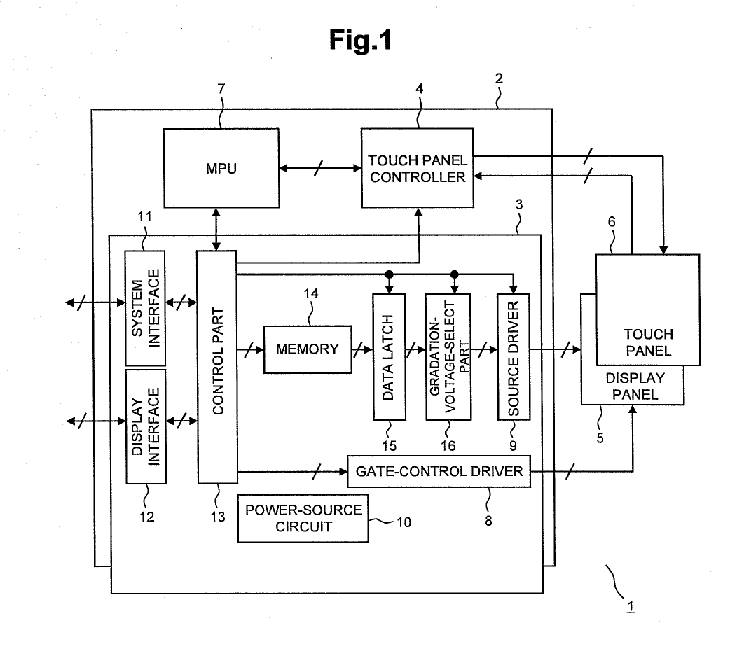

FIG. 1 is a block diagram showing an example of the configuration of a display device according to the invention.

The display device according to the invention includes: a display panel 5 which displays image data of each frame made up of a plurality of lines; and a semiconductor device having a display-drive circuit 3 operable to output drive signals for driving the display panel 5. Although no special restriction is intended, the semiconductor device having the display-drive circuit 3 is formed on a single silicon substrate by e.g. a well-known semiconductor manufacturing technique for CMOS(Complementary Metal-Oxide-Semiconductor field effect transistor) LSI (Large Scale Integrated circuit). The semiconductor device may be a device in which only the display-drive circuit 3 is formed on a single semiconductor substrate, otherwise it may be an IC (Integrated Circuit) 2 with other functional circuits integrated thereinto.

In the display panel 5, a frame is formed by a plurality of lines each constituted by a plurality of pixels, and each pixel has a capacitor for holding an electric charge corresponding, in quantity, to image data. That is, the electric charges corresponding to image data to be displayed in quantity on the corresponding pixels are transmitted to and held by the capacitors in turn. In the display panel 5, the brightness to be displayed on each pixel depends on a potential difference between capacitor electrodes which is produced in proportion to an electric charge held by the capacitor. For instance, in the liquid crystal display panel, capacitor electrodes produce an electric field for polarizing the liquid crystal, and the quantity of light passing through the liquid crystal is controlled according to a quantity of the polarization, which is made the brightness of that pixel. Herein, the drive signals for driving the display panel 5 include: a source-drive signal corresponding to an electric charge corresponding to image data to be displayed in quantity; and a gate-drive signal for specifying a line including a pixel to transmit the electric charge to. The display-drive circuit 3 preferably includes a source driver 9 operable to output the source-drive signal, and a gate-control driver 8 operable to output a signal for producing the gate-drive signal.

Other blocks included in the display device 1 shown in FIG. 1 are to be described later.

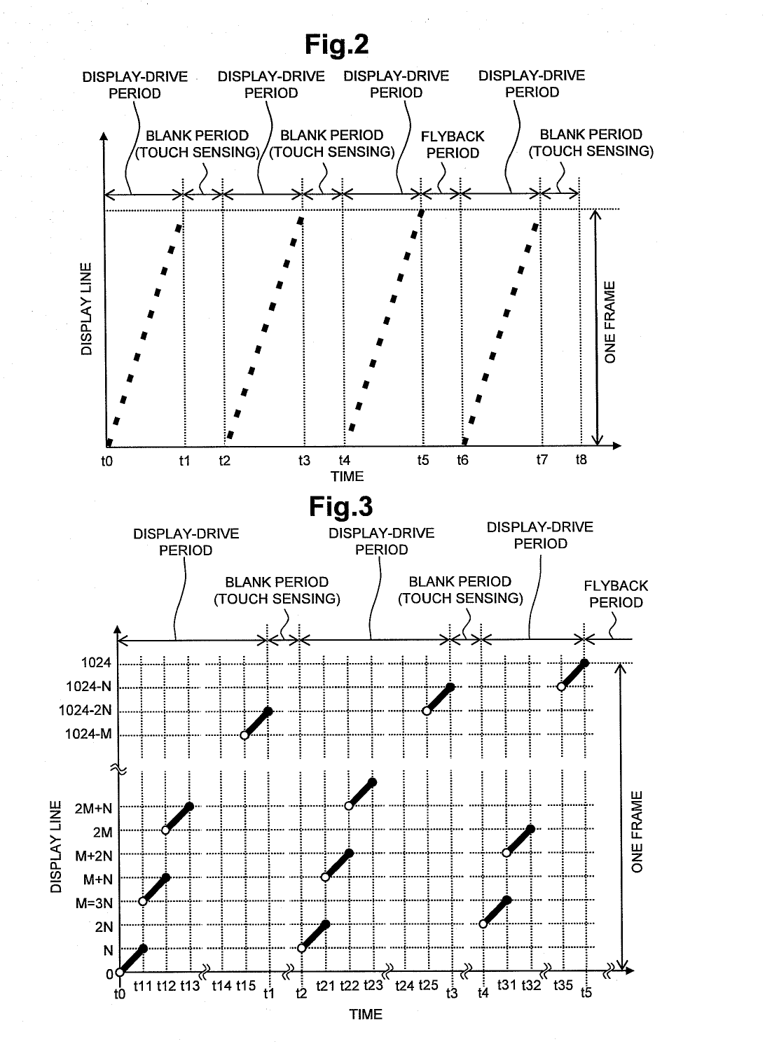

FIG. 2 is a timing diagram for explaining a display action in connection with the representative embodiment of the invention. In the drawing, the horizontal axis shows the time, and the vertical axis shows the number of a line driven for display.

The display-drive circuit 3 is arranged to be able to work according to the time-division technique. In the embodiment shown in FIG. 2, one frame period (the time t0 to t6) includes a first display-drive period (the time t0 to t1), a first blank period (Time t1 to t2), and a second display-drive period (the time t2 to t3) in sequence. Further, one frame period (the time t0 to t6) includes a second blank period (the time t3 to t4), a third display-drive period (the time t4 to t5), and a flyback period (the time t5 to t6) in sequence. The display-drive period from the time t6 to t7, and the blank period from the time t7 to t8 are included in the subsequent frame.

The display-drive circuit 3 drives a group of the lines of the display panel 5 which are distributed according to a predetermined cycle in a frame in the first display-drive period (the time t0 to t1), and keeps the activation of the display panel 5 stopped in the first blank period (the time t1 to t2). In the second display-drive period (the time t2 to t3), the display-drive circuit 3 drives another group of the lines different from the group of the lines which were driven for display in the first display-drive period (the time t0 to t1) in the frame. In the second blank period (the time t3 to t4), the display-drive circuit 3 stops the activation of the display panel 5. Further, in the third display-drive period (the time t4 to t5), the display-drive circuit 3 drives the remaining group of the lines which have not been driven for display in the first display-drive period (the time t0 to t1) or the second display-drive period (the time t2 to t3) in the frame.

The number of display-drive periods in one frame, the number of the lines to be driven for display during one display-drive period, and its cycle can be decided appropriately. Here, “to drive for display” means to drive or activate by a signal for display. On “driving” the display panel, an electric charge is transmitted to the capacitor provided in each pixel. The “driving” is performed according to the time-division technique. Therefore, the electric charges so transmitted are held in the capacitors and accordingly, “display” is performed constantly.

In this way, it becomes possible to provide a semiconductor device having a display-drive circuit for activating a display panel which is arranged so as to make the boundaries between regions produced by the difference in brightness resulting from time-division display harder to visually recognize and to prevent the degradation of display image quality which would result from time-division display.

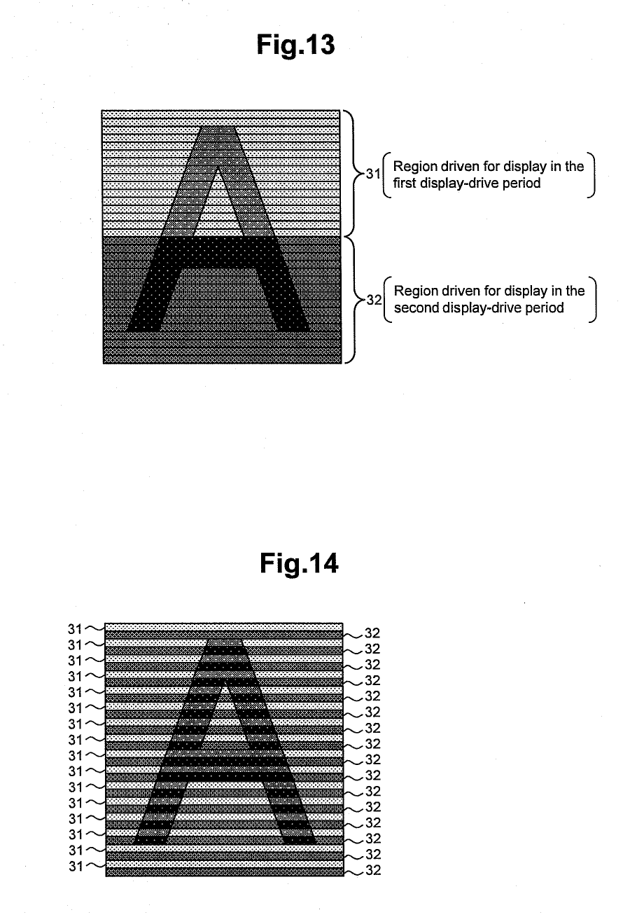

Now, the visual effect which the invention brings about will be described with reference to FIGS. 13 and 14.

FIG. 13 is an explanatory diagram showing an example of image display by a conventional time-division action. FIG. 14 is an explanatory diagram showing an example of image display by time-division actions by the display device according to the invention. Unlike the embodiments described above, the arrangement of one frame period is simplified so that two display-drive periods are set in one frame period for the sake of easier understanding. FIGS. 13 and 14 each show an image displayed by one frame, and a part of the image having higher brightness is hatched in a deeper color.

In the conventional time-division action as described with reference to FIG. 13, after driving an upper half part of one frame for display (the first display-drive period), the display device waits a fixed length of blank period to elapse, and then drives a lower half part of the frame for display (in the second display-drive period). In one display-drive period, electric charges corresponding to image data to be displayed in quantity on pixels are transmitted to and held by the capacitors of the pixels sequentially for each line. After the transmission, the electric charges thus transmitted and held gradually decrease with time owing to the leak from the capacitors or the like. The transmission is performed sequentially in groups of lines from the top in one display-drive period and therefore, decrease of the electric charges is gradually increased from the top on an individual line basis. Since the decreases of the electric charges are smoothly changed in one display-drive period, their differences are imperceptible to the human eye. On the other hand, a decrease of the electric charge at the boundary between a region 31 driven for display in the first display-drive period, and a region 32 driven for display in the second display-drive period changes discontinuously by a decrease in the blank period as shown in FIG. 13. This is because the region 31 driven for display in the first display-drive period uniformly suffer the decrease in electric charge held by each capacitor more than the regions 32 driven for display in the second display-drive period by a decrease in the blank period. The boundary line between the region 31 driven for display in the first display-drive period and the region 32 driven for display in the second display-drive period can be clearly seen with the human eye as shown in FIG. 13. Hence, a line which must not exist originally in an image in which the brightness should be changed smoothly is recognized, which leads to the degradation in display image quality.

In contrast, in the example of image display by the time-division action of the display device according to the invention shown in FIG. 14, the regions 31 driven for display in the first display-drive period and the regions 32 driven for display in the second display-drive period are distributed evenly. It is clear that the differences in brightness of the same degree arise at boundaries, but such differences are harder to recognize with the human eye because the regions 31 and 32 are distributed. The rough distribution is shown in FIG. 14 because of the restriction of representation on a sheet of paper. However, it is sufficient that in an actual display device, the regions 31 and 32 are minutely distributed to the extent that the boundary therebetween cannot be seen with the human eye in light of the size and resolution. In the case of a small display device of a high resolution, it is sufficient that the regions 31 and 32 are distributed in groups of several lines. On the other hand, in regard to a display device of a large size such as a several-tens model, the regions 31 and 32 may be distributed in lines.

<Time-Division Action for Display and Sensing in a Touch Panel-Integrated Display Device>

The other blocks included in the display device 1 shown in FIG. 1 will be described. It is assumed here that the display device 1 includes IC 2 having a display-drive circuit 3 built therein, and a touch panel 6 laminated on a display panel 5. The display panel 5 and the touch panel 6 may be simply put on each other according to On-cell model, or may be integrated into one body according to In-cell model. In addition to the display-drive circuit 3, IC 2 includes a touch panel controller 4 connected with the touch panel 6, and MPU 7 operable to control the whole display device 1.

The touch panel controller 4 is controlled by MPU 7, and it outputs a signal for touch detection to the touch panel 6. The MPU 7 detects a touch coordinate and a touch state based on a touch-sense signal received from the touch panel 6.

The display-drive circuit 3 includes a power supply circuit 10, a system interface 11, a display interface 12, a control part 13, a memory 14, a data latch 15, and a gradation-voltage-select part 16 in addition to the above-described gate-control driver 8 and the source driver 9. The power supply circuit 10 appropriately converts, in level, a power source supplied from the outside, and stabilizes the resultant power source, and then generates operating-power sources for other circuits including drive voltages for the gate-control driver 8 and the source driver 9. The system interface 11 is an interface circuit operable to receive a command from a host, which is connected with the display device 1, and is not shown in the drawing, and operable to output data including detected touch coordinate or the like to the host. The display interface 12 is an interface circuit for receiving image data to be displayed. The control part 13 exchanges commands and data with the system interface 11 and MPU 7. Also, the control part 13 is controlled by MPU 7, and it controls, in timing, the touch panel controller 4, the gate-control driver 8, the source driver 9, the data latch 15, and the gradation-voltage-select part 16, and forwards image data received through the display interface 12 to the memory 14. The image data held by the memory 14 are read out into the data latch 15, and then sent to the gradation-voltage-select part 16. The gradation-voltage-select part 16 selects, based on image data, a gradation voltage of a source line of a pixel to be driven for display, and outputs the selected gradation voltage to the source driver 9. The source driver 9 drives the source line of the display panel 5 by use of the selected gradation voltage.

The control part 13 writes, into the memory 14, image data which are input in the order of sequential scan on a frame to be displayed starting with its top line. In each display-drive period, the control part 13 reads image data in the order of the lines to be displayed in the period out of the memory 14 into the data latch 15. This is because the image data to be displayed are input from the host in the order of sequential scanning from a line on one frame and therefore, it is necessary to permutate the image data so that the image data are arrayed in the order to display the image data in.

According to the arrangement like this, even if image data taken by the conventional raster scan (sequential scan) method are input just in the order of the image being scanned, the display-drive circuit 3 can appropriately permutate the scan, and then output drive signals to the display panel. It is preferable that the memory 14 has a memory capacity enough to store image data of at least one frame. This is because image data of one frame are input to the memory and after that, the image data are read out therefrom for each line to be displayed with a predetermined cycle.

As described above, in each display-drive period, the control part 13 performs the timing control for reading out image data from the memory 14 in the order of the lines to be displayed in the period and in parallel, outputs a timing signal to the touch panel controller 4. Based on the received timing signal, the touch panel controller 4 performs a touch-state-sensing action on the touch panel 6 in a blank period, and stops the touch-state-sensing action in a display-drive.

Now, time-division actions for the driving for display and touch sensing will be described with reference to the timing diagram shown in FIG. 2.

The touch panel controller 4 performs the touch-state-sensing action for sensing the touch state of the touch panel 6 in a blank period, and stops the touch-state-sensing action in a display-drive period. The touch panel controller 4 performs the touch-state-sensing action on the touch panel 6 in the first blank period (the time t1 to t2) and the second blank period (the time t3 to t4), during which the display-drive circuit 3 stops driving the display panel 5. In the first display-drive period (the time t0 to t1), the second display-drive period (the time t2 to t3), and the third display-drive period (the time t4 to t5) during which the display-drive circuit 3 drives the lines of the display panel 5, the touch panel controller 4 stops the touch-state-sensing action on the touch panel 6. Also, the touch panel controller 4 may perform the touch-state-sensing action in a flyback period (the time t5 to t6).

According to the arrangement like this, the detection accuracy in the touch-detecting action can be increased without causing the degradation of display image quality which would result from time-division display even with a display device 1 having a display panel 5 with a touch panel 6 integrally laminated therewith.

While it is ideal that the display driving and the touch-state-detecting action are completely separated in terms of time from each other, the touch-state-detecting action may overlap with the display driving in terms of time as the period in which the touch-state-sensing action is executed eats into the first or second display-drive period. The signal-to-noise ratio (S/N ratio) in the touch-detecting action is increased by reducing the overlap in terms of time, and the best S/N ratio is achieved by reducing the overlap in terms of time. The detection accuracy can be raised by increase in the S/N ratio. In contrast, a longer time can be taken for the touch-detecting action by allowing such temporal overlap and consequently, the detection accuracy can be increased in some cases.

<Distribution in Groups of N Lines with M-Line Cycle>

The action in which the lines are evenly distributed to display-drive periods will be described further in detail.

FIG. 3 is a partially enlarged diagram of the timing diagram shown in FIG. 2. A case in which 1024 lines constitute one frame is taken as an example here. The number of lines forming one frame is not limited to the value. The invention is applicable to a display panel in which one frame is made up of any number of lines.

The display-drive circuit 3 drives: lines of the display panel 5 which are distributed in one frame in groups of N (N is an integer equal to or larger than one) lines with an M-line cycle (M is an integer equal to or larger than one) in the first display-drive period (the time t0 to t1); and lines which are different from the lines driven for display in the first display-drive period (the time t0 to t1), and are distributed in the same frame in groups of N lines with the M-line cycle in the second display-drive period (the time t2 to t3). As shown in FIG. 3, in the first display-drive period (the time t0 to t1), the display-drive circuit 3 drives: lines numbered 1 to N in a period of the time t0 to t11; lines numbered M+1 to M+N in a period of the time t11 to t12; lines numbered 2M+1 to 2M+N in a period of the time t12 to t13; and lines numbered 1024-M+1 to 1024-2N in a period of the time t15 to t1. In the second display-drive period (the time t2 to t3), the display-drive circuit 3 drives: lines numbered N+1 to 2N in a period of the time t2 to t21; lines numbered M+N+1 to M+2N in a period of the time t21 to t22; lines numbered 2M+N+1 to 2M+2N in a period of the time t22 to t23; and lines numbered 1024-2N+1 to 1024-N in a period of the time t25 to t3. In the third display-drive period (the time t4 to t5), the display-drive circuit 3 drives: lines numbered 2N+1 to 3N in a period of the time t4 to t31; lines numbered M+2N+1 to 2M in a period of the time t31 to t32; lines numbered 2M+2N+1 to 2M+3N in a period of the time t32 to t33; and lines numbered 1024-N+1 to 1024 in a period of the time t35 to t5. While FIG. 3 shows, by example, a case of M=3N in which there are three display-drive periods in one frame, the values of M and N can be determined arbitrarily. For instance, regions different in display-drive period are evenly distributed in a time-division action in which the predetermined cycle is an M-line cycle, and M/N display-drive periods are included in one frame period. In the time-division action, M/N blank periods can be provided corresponding to the individual M/N display-drive periods. The blank periods, the total number of which is M/N+1, may be provided before and after each of M/N display-drive periods respectively. Alternatively, the blank periods, the total number of which is M/N−1, may be each provided between the display-drive periods of the same frame. The values of M and N can be determined in the light of the size of the display panel and its resolution (given by the number of lines per frame) so that one frame is divided into sufficiently small regions to the extent that the difference in brightness cannot be seen with the human eye.

According to the arrangement like this, the boundaries between regions different in display-drive period are almost evenly dispersed, and thus the boundaries between regions which are produced by the difference in brightness resulting from time-division display can be made harder to visually recognize and in addition, the degradation of display image quality which would result from time-division display can be prevented.

<In-Panel Gate Control Circuit>

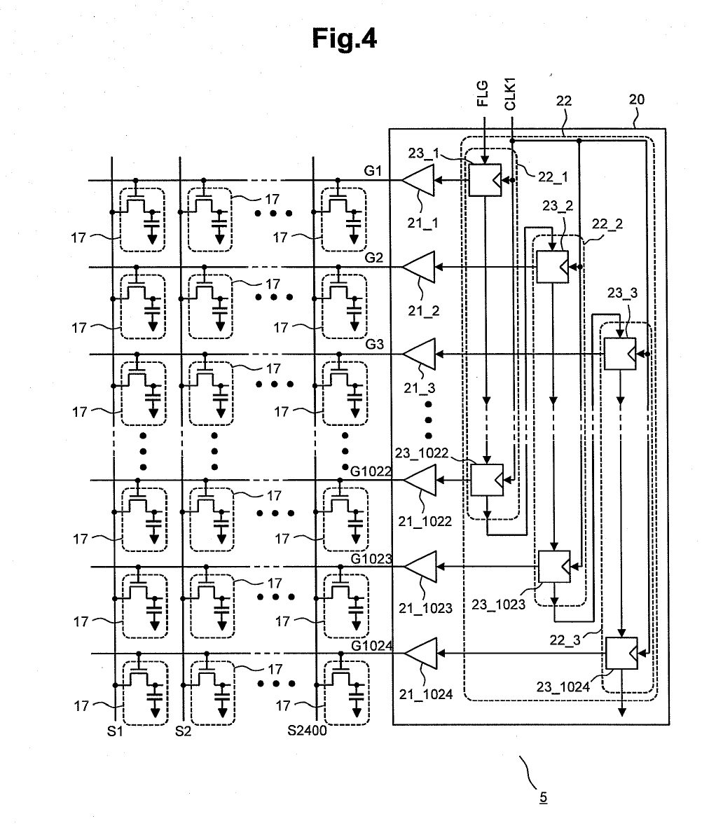

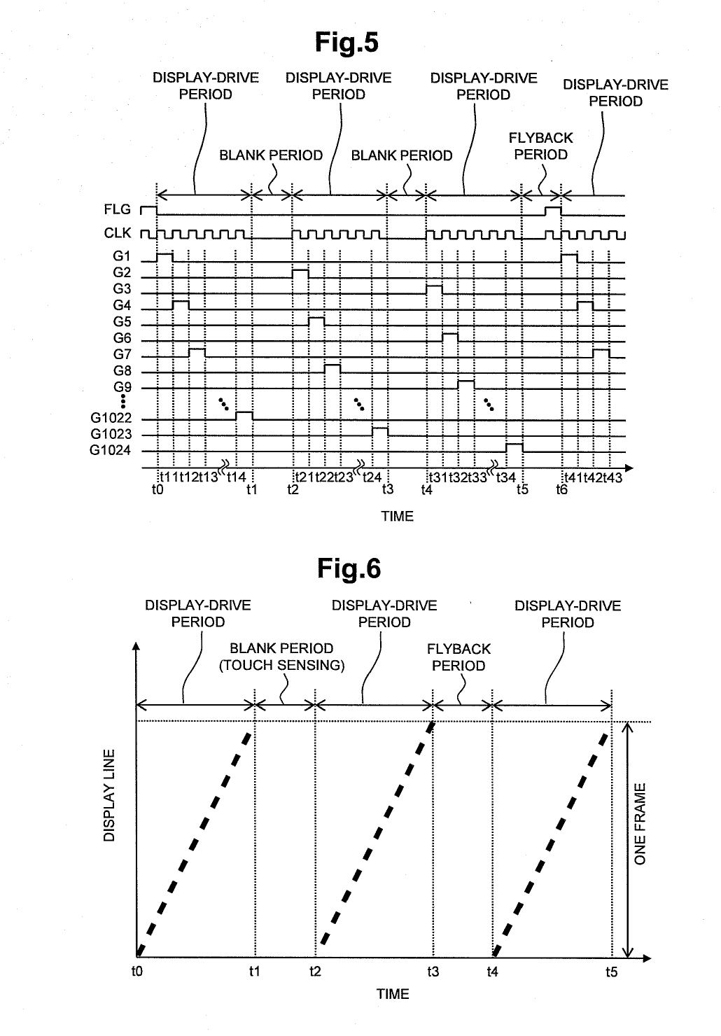

FIG. 4 is a circuit diagram showing an example of the configuration of an in-panel gate control circuit 20 for activating display elements of the display panel 5.

The display panel 5 has a plurality of display elements 17 arranged in two dimensions and an in-panel gate control circuit 20, in which one display element 17 is provided at each intersection point of source lines S1 to S2400 and gate lines G1 to G1024. Each display element 17 is e.g. a liquid crystal element, which includes a transfer gate formed by MOSFET (Metal Oxide Semiconductor Field Effect Transistor) having a source electrode connected to one source line, a gate electrode connected to one gate line, and a drain electrode with a capacitor connected thereto. When selected by the gate line, the transfer gates are put in electrical conduction; a voltage applied to the source line causes an electric charge to transfer to the capacitor. The electric charge thus transferred is held by the capacitor, and applied to the liquid crystal. The liquid crystal is controlled in polarization of light according to the electric charge applied thereto, and thus changed in its light transmittance. The display brightness is controlled in this way in the display panel 5. The liquid crystal elements 17 are provided one for each pixel, whereas in the case of a color display panel, a number of liquid crystal elements corresponding to the number of colors, usually three liquid crystal elements are provided for each pixel. In the embodiment shown in FIG. 4, one frame is constituted by 1024 lines each including 2400 elements, and one liquid crystal element 17 is provided for each pixel. The number of lines per frame, and the number of pixels per line are arbitrary; in the case of a color display panel, it is sufficient to provide a number of the circuits corresponding to the number of colors, usually three sets of circuits for each pixel. Likewise, this applies to all of the other drawings, and other embodiments.

The in-panel gate control circuit 20 has a general shift register 22 including a plurality of gate drivers 21_1 to 21_1024 for driving the gate lines G1 to G1024, and a plurality of partial shift registers 22_1 to 22_3 cascade-connected thereto. The partial shift registers 22_1 to 22_3 have memory elements; the memory elements are cascade-connected in lines with a 3-line cycle. Each memory element is e.g. a flip-flop 23. The partial shift register 221 has flip-flops 23_1, 23_4, 23_7, . . . , 23_1022 which are cascade-connected in lines with a 3-line cycle. The partial shift register 22_2 has flip-flops 23_2, 23_5, 23_8, . . . , 23_1023 which are cascade-connected in lines with a 3-line cycle. The partial shift register 22_3 has flip-flops 23_3, 23_6, 23_9, . . . , 23_1024 which are cascade-connected in lines with a 3-line cycle.

In the general shift register 22, the partial shift register 22_1 of the first stage accepts the input of a flag FLG indicative of a line to be driven for display from the display-drive circuit 3; the line to be driven for display is shifted in turn by a clock CLK which is input in combination with the flag FLG.

According to the arrangement like this, the number of signal lines between the display-drive circuit and the display panel can be reduced.

While in the embodiment shown in FIG. 4, the number of the partial shift registers included in the general shift register is three, and the flip-flops are provided in lines with a 3-line cycle, the invention is not limited to the embodiment like this. The number of the partial shift registers included in the general shift register is the same as the number of display-drive periods in one frame. On the partial shift registers, the memory elements may be provided in groups of N lines with an M-line cycle in the same way as the lines are distributed in display driving.

The action of the in-panel gate control circuit 20 will be described here.

FIG. 5 is a timing diagram for explaining the action of the in-panel gate control circuit shown in FIG. 4. In the drawing, the horizontal axis shows the time; in the vertical direction, waveforms of the flag FLG, the clock CLK, and the gate lines G1 to G1024 are shown from the top in turn. The display-drive period is started in response to input of the flag FLG. Just before the time t0, the flag FLG is input, and is taken into the first stage flip-flop 23_1 of the first stage partial shift register 22_1 in the general shift register 22 according to the clock CLK input in parallel with the flag. First, in the first display-drive period (the time t0 to t1), the gate driver 21_1 which the flag FLG forwarded to the flip-flop 23_1 is input to drives the gate line G1 at the time to. Subsequently, the gate line G4 is driven at the time t11, and the gate line G7 is driven at t12. Since then, the flag FLG is shifted in turn until the gate line G1022 is driven at the time t14. In the blank period (the time t1 to t2), the clock CLK is stopped, and the flag FLG is not forwarded. Subsequently, in the second display-drive period (the time t2 to t3), an output from the partial shift register 22_1 is transmitted to the next partial shift register 22_2. The gate driver 21_2 which the flag FLG transmitted to the first stage flip-flop 23_2 of the partial shift register 22_2 is to be input to drives the gate line G2 at the time t2. Next, the gate line G5 is driven at the time t21 and further, the gate line G8 is driven at t22. Since then, the flag FLG is shifted in turn until the gate line G1023 is driven at the time t24. In the blank period (the time t3 to t4), the clock CLK is stopped, and the flag FLG is not forwarded. Subsequently, in the third display-drive period (the time t4 to t5), an output from the partial shift register 22_2 is forwarded to the next partial shift register 22_3. The gate driver 21_3 which the flag FLG transmitted to the first stage flip-flop 23_3 of the partial shift register 22_3 is to be input to drives the gate line G3 at the time t4. Next, the gate line G6 is driven at the time t31, and the gate line G9 is driven at the time t32. Since then, the flag FLG is shifted in turn until the gate line G1024 is driven at the time t34. In the flyback period (the time t5 to t6), the clock CLK is stopped, and the flag FLG is not forwarded.

According to the above-described action, 1024 lines in one frame will be evenly distributed to three display-drive periods in lines with a 3-line cycle, and driven for display. As a result, it becomes possible to provide a semiconductor device having a display-drive circuit for activating a display panel which is arranged so as to make the boundaries between regions produced by the difference in brightness resulting from time-division display harder to visually recognize and to prevent the degradation of display image quality which would result from time-division display.

### First Embodiment

### Alternate Distribution in Lines

In the first embodiment, the display-drive circuit 3 performs the time-division action so that two display-drive periods are included in one frame, and alternately drives the lines for display in lines in each display-drive period. For instance, the display-drive circuit 3 drives odd-numbered lines for display in one of the display-drive periods, and drives even-numbered lines for display in the other display-drive period.

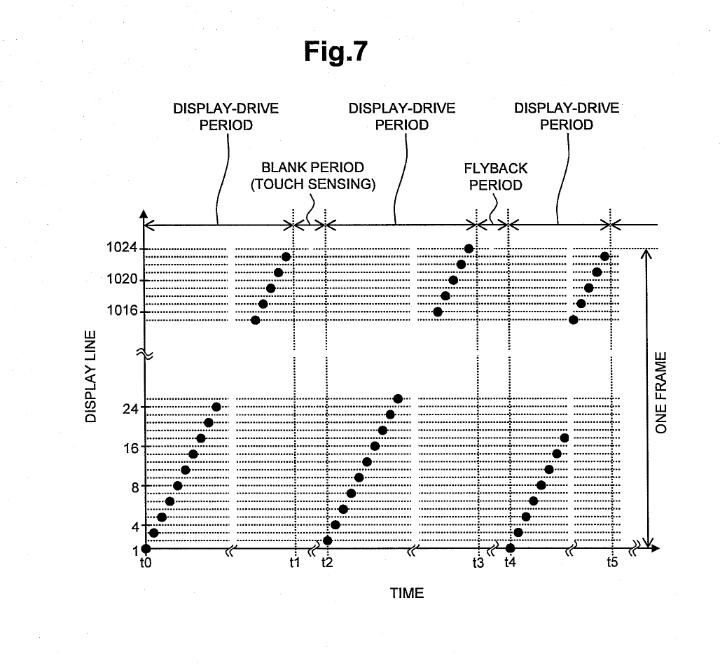

FIG. 6 is a timing diagram for explaining the display action according to the first embodiment, and FIG. 7 is a partially enlarged diagram of the timing diagram shown in FIG. 6.

The display-drive circuit has, in one frame, the first display-drive period (the time t0 to t1) and the second display-drive period (the time t2 to t3) and further, a blank period (the time t1 to t2) and a flyback period (the time t3 to t4). The display-drive period from the time t4 to t5 is for display of the subsequent frame. In the blank period (the time t1 to t2) and the flyback period (the time t3 to t4), the touch-state-detecting action may be performed. As shown in FIG. 7, the display-drive circuit drives the odd-numbered lines of the 1^{st} to 1023^{th} lines for display with a 2-line cycle in the first display-drive period (the time t0 to t1), and drives the even-numbered lines of the 2^{nd} to 1024^{th} lines for display with a 2-line cycle in the second display-drive period (the time t2 to t3). In the first display-drive period (the time t4 to t5) for the subsequent frame, the display-drive circuit drives the odd-numbered lines for display.

According to the arrangement like this, regions driven in different display-drive periods are alternately distributed in lines, and thus such regions are evenly and most minutely distributed. Therefore, the boundaries between regions produced by the difference in brightness resulting from time-division display can be made harder to visually recognize and further, the degradation of display image quality which would result from time-division display can be prevented.

<In-Panel Gate Control Circuit Provided with a Pair of Shift Registers for Distribution in Lines with a 2-Line Cycle>

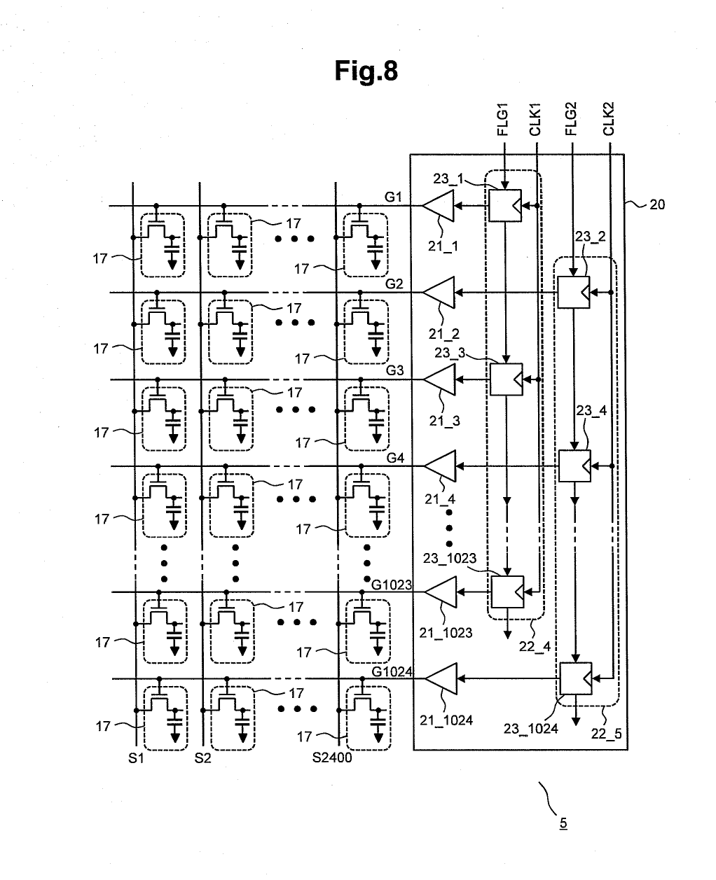

FIG. 8 is a circuit diagram showing an example of the configuration of the in-panel gate control circuit in the display device according to the first embodiment.

The display panels of FIGS. 4 and 8 have, in common, a plurality of display elements 17 arranged in two dimensions and therefore, the description thereof is omitted here. It is also a commonality that the in-panel gate control circuit 20 has gate drivers 21_1 to 21_1024 for driving the gate lines G1 to G1024 and as such, the description thereof is skipped likewise. The in-panel gate control circuit 20 includes a pair of shift registers 22_4 and 22_5; in each group, memory elements are provided in lines with a 2-line cycle. The shift register 22_4 has, as such memory elements, cascade-connected flip-flops 23_1, 23_3, . . . , 23_1023. The shift register 22_5 includes cascade-connected flip-flops 23_2, 23_4, . . . , 23_1024. To the shift register 22_4, a flag 1 (FLG1) and a clock 1 (CLK1) are input. The input flag 1 (FLG1) is shifted by the clock 1 (CLK1) in turn. To the shift register 22_5, a flag 2 (FLG2) and a clock 2 (CLK2) are input. The input flag 2 (FLG2) is shifted by the clock 2 (CLK2) in turn.

According to the arrangement like this, a circuit for distributing a display region in lines with a 2-line cycle (or in lines alternately) can be configured readily.

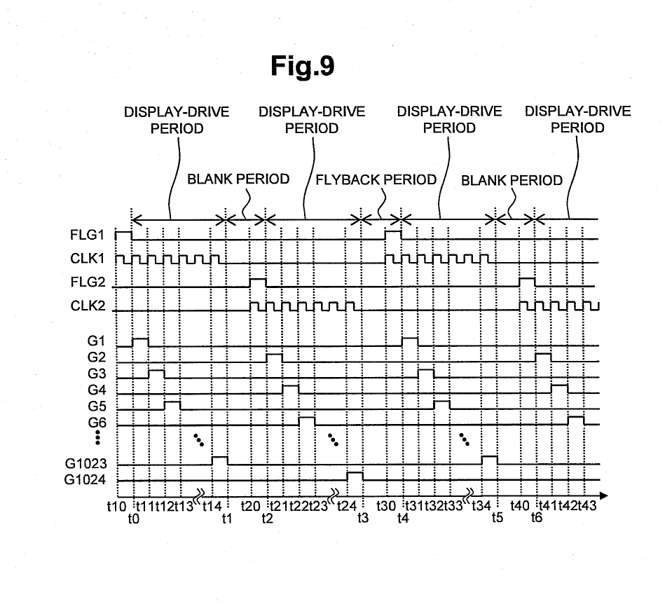

FIG. 9 is a timing diagram for explaining the action of the in-panel gate control circuit shown in FIG. 8. The horizontal axis is a time scale; in the vertical direction, waveforms of the flag 1 (FLG1), the clock 1 (CLK1), the flag 2 (FLG2), the clock 2 (CLK2), and the gate lines G1 to G1024 are shown from the top in turn. The flag 1 (FLG1) is input, and then the first display-drive period is started. At the time t10, the flag 1 (FLG1) is input, and is taken into the first stage flip-flop 23_1 of the shift register 22_4 according to the clock 1 (CLK1) input in parallel with the flag. First, in the first display-drive period (the time t0 to t1), the gate driver 21_1 which the flag 1 (FLG1) forwarded to the flip-flop 23_1 is input to drives the gate line G1 at the time t0. Subsequently, the gate line G3 is driven at the time t11, and the gate line G5 is driven at the time t12. Since then, the flag 1 (FLG1) is shifted in turn until the gate line G1023 is driven at the time t14. In the blank period (the time t1 to t2), the clock 1 (CLK1) and the clock 2 (CLK2) are both stopped, and neither the flag 1 (FLG1) nor the flag 2 (FLG2) is forwarded. Subsequently, the flag 2 (FLG2) is input, and then the second display-drive period is started. At the time t20, the flag 2 (FLG2) is input, and is taken into the first stage flip-flop 23_2 of the shift register 22_5 according to the clock 2 (CLK2) input in parallel with the flag 2. First, in the second display-drive period (the time t2 to t3), the gate driver 21_2 which the flag 2 (FLG2) forwarded to the flip-flop 23_2 is input to drives the gate line G2 at the time t2. Subsequently, the gate line G4 is driven at the time t21, and the gate line G6 is driven at t22. Since then, the flag 2 (FLG2) is shifted in turn until the gate line G1024 is driven at the time t24. In the flyback period (the time t3 to t4), the clock 1 (CLK1) and the clock 2 (CLK2) are both stopped, and neither the flag 1 (FLG1) nor the flag 2 (FLG2) is forwarded.

According to the action described above, the 1024 lines in one frame are evenly distributed to the two display-drive periods in lines with the 2-line cycle, and are driven for display. In this way, it becomes possible to provide a semiconductor device having a display-drive circuit for activating a display panel which is arranged so as to make the boundaries between regions produced by the difference in brightness resulting from time-division display harder to visually recognize and to prevent the degradation of display image quality which would result from time-division display.

To the shift register 22_5, an output of the flip-flop 23_1023 of the last stage of the shift register 22_4, and the clock 1 (CLK1) may be input instead of a combination of the flag 2 (FLG2) and the clock 2 (CLK2). In this case, the action of the in-panel gate control circuit 20 of FIG. 8 is the same as that of the in-panel gate control circuit 20 shown in FIG. 4. In addition, the signal lines for input to in-panel gate control circuit 20 may be composed of a total of two lines for the flag 1 (FLG1) and for the clock 1 (CLK1). On the other hand, the load of the clock to each shift register can be made one-half by providing two shift registers 22_4 and 22_5 independently of each other as shown in FIG. 8. In addition, the electric power consumed for clock activation can be reduced to one fourth by keeping the clock 2 (CLK2) stopped during the first display-drive period, and keeping the clock 1 (CLK1) stopped during the second display-drive period as shown in FIG. 9. Further, the shift registers 22_4 and 22_5 work independently of each other, which facilitates the embodiments in disclosed in “Second embodiment” and “Third embodiment” to be described later.

### Second Embodiment

### In-Panel Gate Control Circuit with a Pair of Shift Registers Disposed on Both Sides of the Display Panel

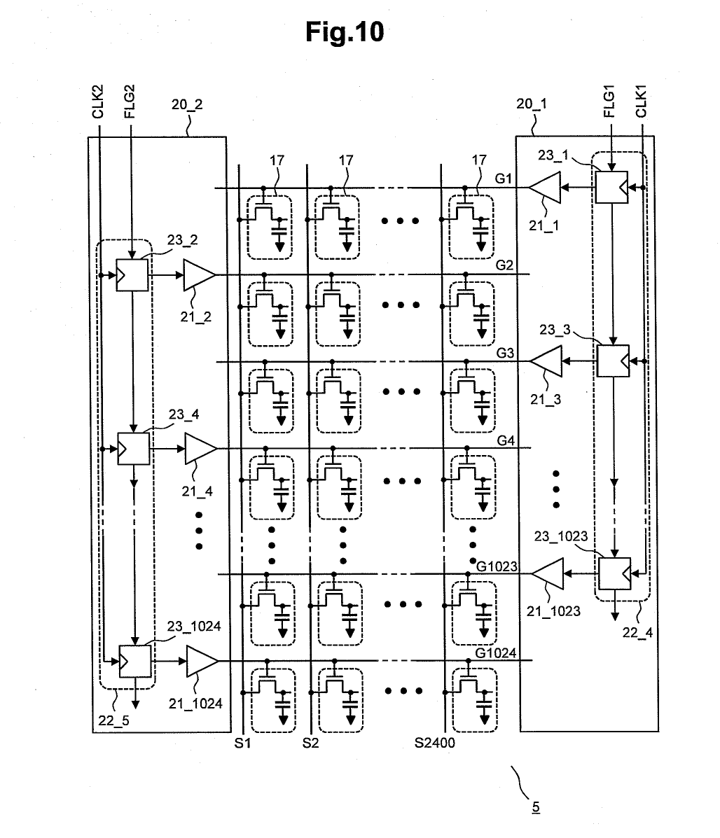

FIG. 10 is a circuit diagram showing an example of the configuration of the in-panel gate control circuit in the display device according to the second embodiment. The in-panel gate control circuit 20 of the display panel is divided into: an in-panel gate control circuit 20_1 for driving gates of odd-numbered lines; and an in-panel gate control circuit 20_2 for driving gates of even-numbered lines. The in-panel gate control circuit 20_1 for driving the gates of the odd-numbered lines includes gate drivers 2_1, 21_3, . . . , 21_1023, to which outputs of flip-flops 23_1, 23_3, . . . , 23_1023 constituting a shift register 22_4 are input respectively; the gate drivers 2_1, 21_3, . . . , 21_1023 provide outputs to the gate lines G1, G3, . . . , G1023 respectively. The in-panel gate control circuit 20_2 for driving the gates of the even-numbered lines includes gate drivers 21_2, 21_4, . . . , 21_1024, to which outputs of flip-flops 23_2, 23_4, . . . , 23_1024 constituting a shift register 22_5 are input respectively; the gate drivers 21_2, 21_4, . . . , 21_1024 provide outputs to the gate lines G2, G4, . . . , G1024.

It is preferred that the in-panel gate control circuit 20_1 and the in-panel gate control circuit 20_2 are disposed in regions which sandwich therebetween a display region, namely regions on two opposing sides of the display region, provided that the display region has therein a plurality of display elements 17 of the display panel 5 arranged in two dimensions.

According to the arrangement like this, the in-panel gate control circuit 20 can be disposed efficiently. This is because the pitch of gate drivers 21 for driving the gate lines, and the pitch of the memory elements (flip-flops) 23 constituting the shift registers, which are allowable in terms of layout, are enlarged to twice the gate line pitch.

By providing the shift registers 22_4 and 22_5 independently of each other, to which a combination of the flag 1 (FLG1) and the clock 1 (CLK1) and a combination of the flag 2 (FLG2) and the clock 2 (CLK2) are input respectively, the shift registers 22_4 and 22_5 can be disposed in regions which sandwich therebetween a display region where the display elements 17 of the display panel 5 are arranged in two dimensions, namely regions on both opposing sides of the display region.

### Third Embodiment

### To Change the Order of Regions Displayed in Successive Frames

As to the above-described embodiments, the descriptions have been made on the assumption that the numerals allocated to the lines driven in each display-drive period are unchanged among frames, i.e. the order of the lines driven for display in each frame is fixed. For instance, assumption is made as follows. As to a frame, the gate lines G1, G4, G7, . . . are driven in the first display-drive period, and the gate lines G2, G5, G8, . . . are driven in the second display-drive period, and the gate lines G3, G6, G9, . . . are driven in the third display-drive period. Likewise, with the subsequent frame, the same gate lines G1, G4, G7, . . . are driven in the first display-drive period, the gate lines G2, G5, G8, . . . are driven in the second display-drive period, which are the same as those driven in the second display-drive period for a preceding frame, and the gate lines G3, G6, G9, . . . are driven in the third display-drive period, which are the same as those driven in the third display-drive period for the preceding frame.

In contrast, in the third embodiment, the order of regions to be displayed is changed between successive frames.

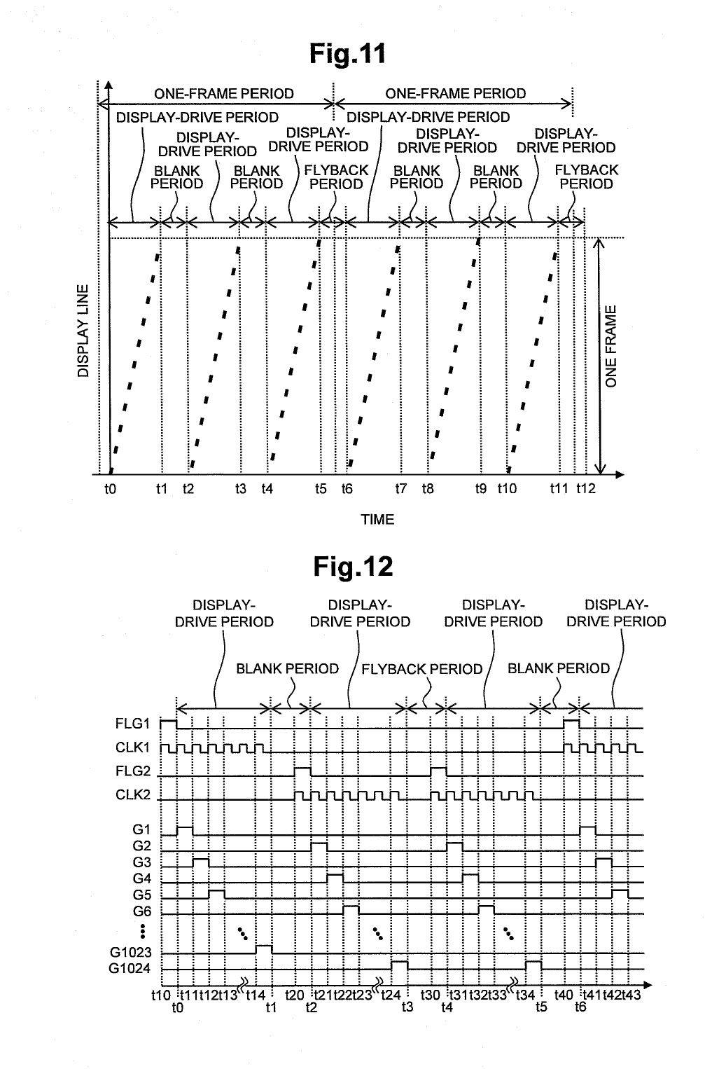

FIG. 11 is a timing diagram for explaining the display action according to the third embodiment.

In the first frame period from the time t0 to t6, the display-drive circuit 3 drives lines distributed in one frame with a predetermined cycle in first display-drive period (the time t0 to t1) in the same way as described with reference to FIG. 2. In the second display-drive period (the time t2 to t3), the display-drive circuit 3 drives the lines which are different from the lines driven for display in the first display-drive period (the time t0 to t1) of the first frame. In the third display-drive period (the time t4 to t5), the display-drive circuit 3 drives the remaining lines which have not been driven for display in the first display-drive period (the time t0 to t1) of the first frame or in the second display-drive period (the time t2 to t3) thereof.

In the second frame period from the time t6 to t12, the display-drive circuit 3 drives, in the first display-drive period (the time t6 to t7), the lines different from those driven in the first display-drive period (the time t0 to t1) of the first frame, e.g. the lines driven in the second display-drive period (the time t2 to t3) of the first frame. In the second display-drive period (the time t8 to t9) of the second frame, the display-drive circuit 3 drives the lines which are different from those driven in the first display-drive period (the time t6 to t7) of the second frame, and different from those driven in the second display-drive period (the time t2 to t3) of the first frame, e.g. the lines driven in the third display-drive period (the time t4 to t5) of the first frame. In the third display-drive period (the time t10 to t11) of the second frame, the display-drive circuit 3 drives the remaining lines which have not been driven for display in the first display-drive period (the time t6 to t7) of the second frame or in the second display-drive period (the time t8 to t9) thereof.

According to the arrangement like this, the difference in brightness resulting from time-division display is dispersed along the time axis direction because it varies by frame and consequently, the boundaries of regions become harder to visually recognize. In addition, even if the performance of a pixel keeping electric charge varies from pixel to pixel, the boundaries between regions which are produced by the difference in brightness resulting from time-division display become harder to visually recognize. Thus, the degradation of display image quality which would result from time-division display is prevented.

<Alternating Display of Odd-Numbered Lines and Even-Numbered Lines in Successive Frames>

While the above description has been made taking as an example the case in which a one-frame period includes three display-drive periods, the number of display-drive periods included in a one-frame period is arbitrary.

Hence, the display device is arranged as follows. On condition that the number of display-drive periods in the one-frame period is two, odd-numbered lines are driven in the first display-drive period of the first frame, and even-numbered lines are driven in the second display-drive period of the first frame; and even-numbered lines are driven in the first display-drive period of the subsequent second frame, and odd-numbered lines are driven in the second display-drive period of the second frame.

FIG. 12 is a timing diagram for explaining the action of the in-panel gate control circuit 20 in the display device according to the third embodiment. The horizontal axis is a time scale; in the vertical direction, waveforms of the flag 1 (FLG1), the clock 1 (CLK1), the flag 2 (FLG2), the clock 2 (CLK2), and the gate lines G1 to G1024 are shown from the top in turn. The action on the first frame from the time t0 to t4 is the same as the action described with reference to the timing diagram of FIG. 9 and therefore, the description thereof is skipped here. As shown in the drawing, odd-numbered lines are driven in the first display-drive period (the time t0 to t1) of the first frame; and even-numbered lines are driven in the second display-drive period (the time t2 to t3). In the timing diagram shown in FIG. 9, the same odd-numbered lines as those driven in the first display-drive period (the time t0 to t1) of the first frame are driven in the first display-drive period (the time t4 to t5) of the second frame; and the same even-numbered lines those driven in the second display-drive period (the time t2 to t3) of the first frame are driven in the second display-drive period (from the time t6). On the other hand, in the timing diagram for explaining the action of the in-panel gate control circuit 20 in the display device according to the third embodiment shown in FIG. 12, even-numbered lines different from the lines driven in the first display-drive period (the time t0 to t1) of the first frame are driven in the first display-drive period (the time t4 to t5) of the second frame; and odd-numbered lines different from the lines driven in the second display-drive period (the time t2 to t3) of the first frame are driven in the second display-drive period (from the time t6)

According to the arrangement like this, a display-drive period in which odd-numbered lines are driven for display and a display-drive period in which even-numbered lines are driven for display are alternated between the first and second display-drive periods for each frame. Therefore, even if the performance of a pixel keeping electric charge varies from pixel to pixel, the boundaries between regions which are produced by the difference in brightness resulting from time-division display can be made harder to visually recognize, and the degradation of display image quality which would result from time-division display can be prevented.

It is preferred to adopt the in-panel gate control circuit 20 as shown in FIG. 8 for the display device of the third embodiment. Since a combination of the flag 1 (FLG1) and the clock 1 (CLK1), and a combination of the flag 2 (FLG2) and the clock 2 (CLK2) can be input independently of each other, the action of alternating the order of display in each frame, which has been described with reference to the timing diagram of FIG. 12 can be controlled readily.

### Fourth Embodiment

### Data Compression and Decompression in Groups of Lines

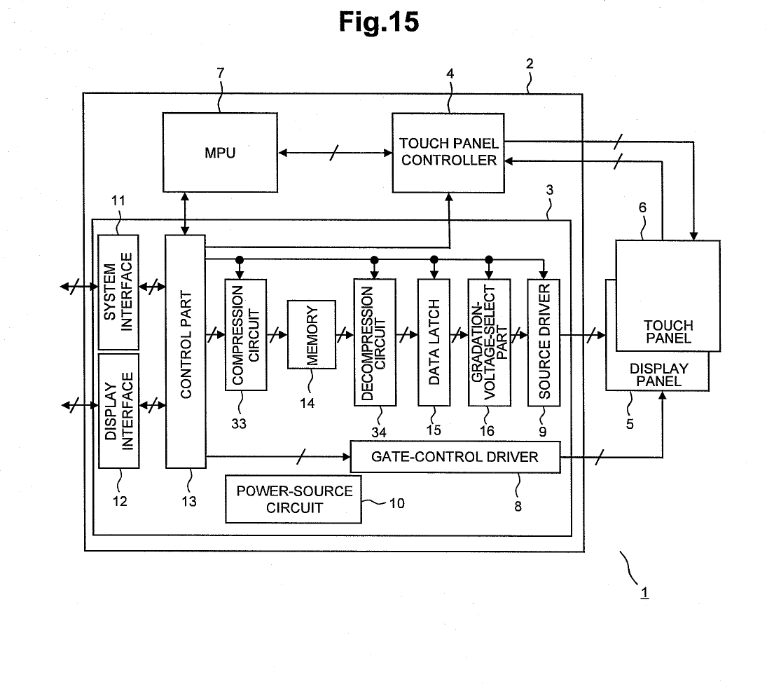

FIG. 15 is a block diagram showing an example of the configuration of a display device according to the fourth embodiment. Unlike the example of the configuration of the display device shown in FIG. 1, the display-drive circuit 3 further includes a compression circuit 33 and a decompression circuit 34.

The control part 13 accepts the input of image data in the order of sequential scan from the top line in a frame to be displayed, compresses the image data by means of the compression circuit 33, and writes the image data thus compressed into the memory 14. In each display-drive period, the control part 13 reads, from the memory 14, compressed data including image data of a line to be displayed during that period. The decompression circuit 34 restores image data of a line to be displayed by decompressing compressed data read from the memory 14, and transmits the restored image data to the data latch 15. Thereafter, the display-drive circuit 3 produces the drive signals based on the restored image data in the same way as described above concerning the representative embodiment. Other constituent parts operate in the same ways as described above concerning the representative and other embodiments.

According to the arrangement like this, even if image data taken by the conventional raster scan (sequential scan) method are input just in the order of the image being scanned, the display-drive circuit 3 can appropriately permutate the scan, and then output drive signals to the display panel. It is preferable that the memory 14 has a memory capacity enough to store image data of at least one frame. This is because image data of one frame are input to the memory and after that, the image data are read out therefrom for each line to be displayed with a predetermined cycle. Since image data are compressed at the time of write into the memory, and decompressed after having been read out therefrom, the capacity of the memory 14 can be kept small.

The display-drive circuit 3 drives, in each display-drive period, a plurality of lines for display, in which the lines are almost evenly distributed in groups of N lines (N is an integer equal to or larger than one) with an M-line cycle (M is an integer equal to or larger than one) in one frame. While the values of M and N can be set appropriately, the compression circuit 33 executes the data compression of image data in groups of N lines, and the decompression circuit 34 decompress the compressed data in groups of N lines, thereby restoring the image data in the fourth embodiment.

According to the arrangement like this, the compression circuit 33 and the decompression circuit 34 can be operated efficiently. In addition, the number of lines forming a unit of data compression is made N, and the driving for display is performed in the same units, i.e. in groups of N lines. In other words, N lines of image data to be displayed are compressed and stored, and decompressed as a unit of image compression and decompression. As a result, the decompressed image data agree with displayed image data, and no waste is caused in decompressed image data.

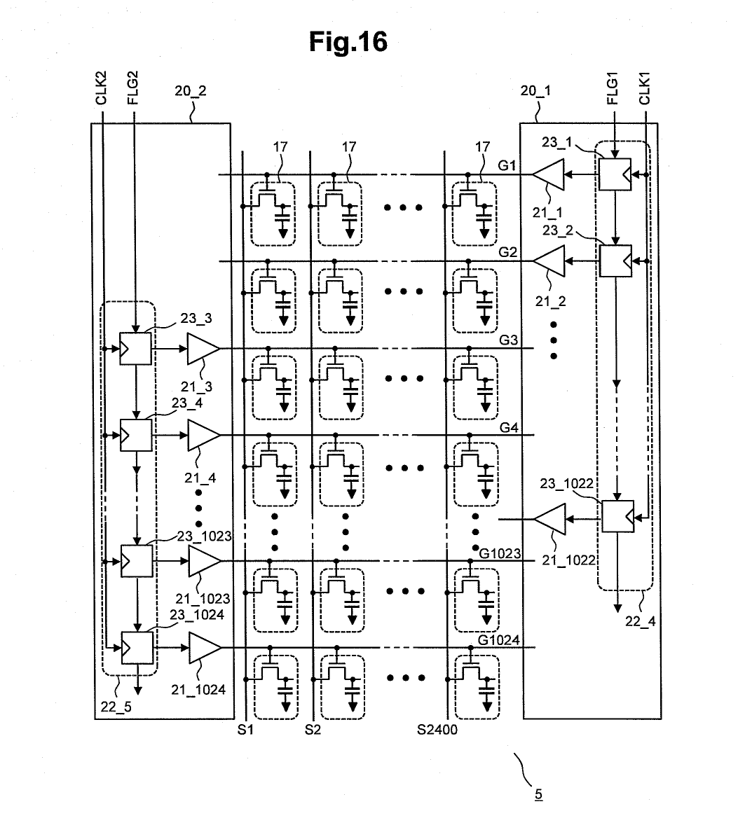

FIG. 16 is a circuit diagram showing an example of the configuration of a pair of in-panel gate control circuits in the display device according to the fourth embodiment. In this embodiment, M=4 and N=2. Setting the number of lines forming a unit of image compression to two, a data compression algorithm for images which utilizes the characteristic peculiar to an ordinary image that a pixel has a strong correlation to data of pixels adjacent thereto in its up-and-down direction can be adopted. The data are compressed in pairs of lines, and decompressed and restored in pairs of lines. Therefore, a design which causes no waste in terms of the action of the decompression circuit 34 can be achieved by driving for display in the same units, i.e. in pairs of lines. If the number of lines forming a unit of image compression is made three or four, a data compression algorithm for images which further efficiently utilizes the characteristic peculiar to an ordinary image that a pixel has a strong correlation to data of pixels adjacent thereto in its up-and-down direction can be adopted. In this case, a design which causes no waste in terms of the action of the decompression circuit 34 can be achieved by bringing the number of lines forming a unit of data compression and the number of lines (N lines) forming a unit of driving for display into agreement with each other.

The display panel 5 according to the fourth embodiment shown in FIG. 16 has a plurality of display elements 17 arranged in two dimensions and a pair of in-panel gate control circuits 20_1 and 20_2 as in the display panel shown in FIG. 10, in which one display element 17 is provided at each intersection point of source lines S1 to S2400 and gate lines G1 to G1024.

The in-panel gate control circuit 20_1 includes gate drivers 21_1, 21_2, 21_5 (not shown), 21_6 (not shown), . . . , 21_1021 (not shown), and 21_1022, wherein outputs from the flip-flops 23_1, 23_2, 23_5 (not shown), 23_6 (not shown), . . . , 23_1021 (not shown), and 23_1022 included in the shift register 22_4 are input to the gate drivers respectively, and the gate drivers provide outputs to the gate lines G1, G2, G5 (not shown), G6 (not shown), . . . , G1021 (not shown), and G1022 respectively.

The in-panel gate control circuit 20_2 has gate drivers 21_3, 214, 21_7 (not shown), 218 (not shown), . . . , 21_1023, and 21_1024, wherein outputs from the flip-flops 23_3, 23_4, 23_7 (not shown), 23_8 (not shown), . . . , 23_1023, and 23_1024 included in the shift register 22_5 are input to the gate drivers respectively, and the gate drivers provide outputs to the gate lines G3, G4, G7 (not shown), G8 (not shown), . . . , G1023, and G1024 respectively.

To the shift registers 22_4 and 22_5, a combination of a flag 1 (FLG1) and a clock 1 (CLK1), and a combination of a flag 2 (FLG2) and a clock 2 (CLK2) are input respectively.

According to the arrangement like this, the number of signal lines between the display-drive circuit and the display panel can be reduced, and a circuit for distributing a display region in groups of N lines, i.e. in groups of a number of lines which is the unit of image compression with an M-line cycle can be configured readily. In addition, it becomes possible to readily dispose the in-panel gate control circuits 20_1 and 20_2 in regions which sandwich therebetween a display region where the display elements 17 of the display panel 5 are arranged in two dimensions, namely on both opposing sides of the display region.

The actions of the in-panel gate control circuits 20_1 and 20_2 will be described.

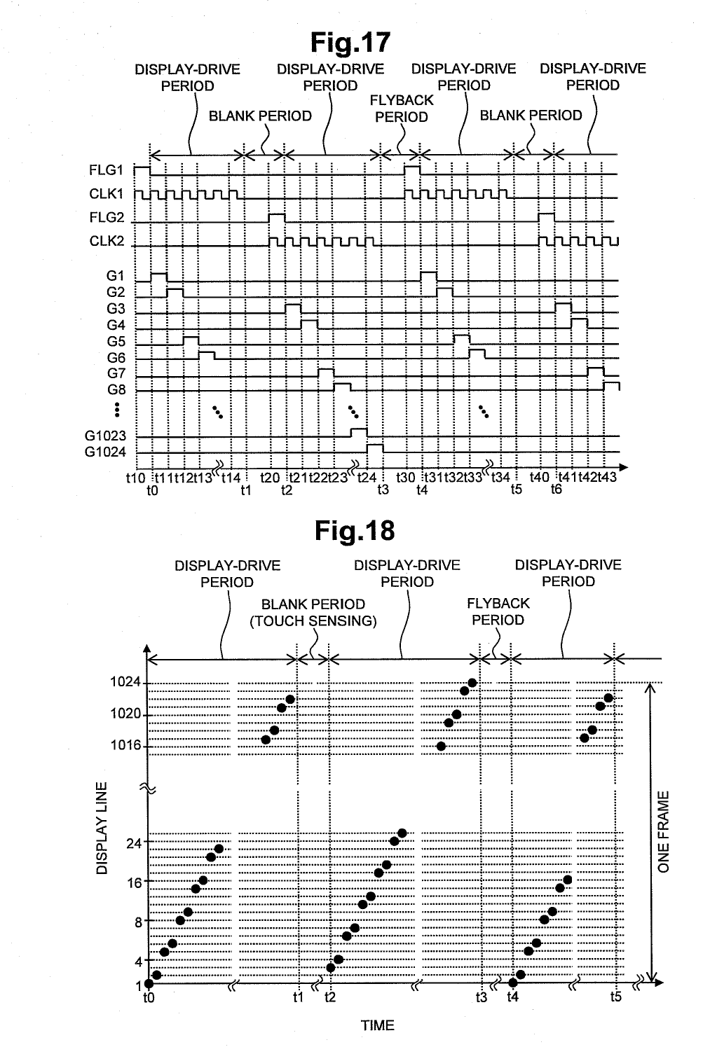

FIG. 17 is a timing diagram for explaining the action of the pair of in-panel gate control circuits shown in FIG. 16. The horizontal axis is a time scale; in the vertical direction, waveforms of the flag 1 (FLG1), the clock 1 (CLK1), the flag 2 (FLG2), the clock 2 (CLK2), and the gate lines G1 to G1024 are shown from the top in turn. The display-drive period is started in response to input of the flag 1 (FLG1). The flag 1 (FLG1) is input at the time t10, and is taken into the first stage flip-flop 23_1 of the shift register 22_4 according to the clock 1 (CLK1) input in parallel with the flag 1. First, in the first display-drive period (the time t0 to t1), the gate driver 21_1 which the flag 1 (FLG1) forwarded to the flip-flop 23_1 is input to drives the gate line G1 at the time t0. Subsequently, the gate line G2 is driven at the time t11, and the gate line G5 is driven at t12. Since then, the flag 1 (FLG1) is shifted in turn until the gate line G1022 is driven. In the blank period (the time t1 to t2), the clock 1 (CLK1) and the clock 2 (CLK2) are both stopped, and neither the flag 1 (FLG1) nor the flag 2 (FLG2) is forwarded. Next, the flag 2 (FLG2) is input, and then the second display-drive period is started. The flag 2 (FLG2) is input at the time t20, and is taken into the first stage flip-flop 23_3 of the shift register 22_5 according to the clock 2 (CLK2) input in parallel with the flag 2. In the second display-drive period (the time t2 to t3), the gate driver 21_3 which the flag 2 (FLG2) forwarded to the flip-flop 23_3 is input to first drives the gate line G3 at the time t2. Subsequently, the gate line G4 is driven at the time t21, and the gate line G7 is driven at the time t22. Since then, the flag 2 (FLG2) is shifted in turn until the gate line G1024 is driven at the time 24. In the flyback period (the time t3 to t4), the clock 1 (CLK1) and the clock 2 (CLK2) are both stopped, and neither the flag 1 (FLG1) nor the flag 2 (FLG2) is forwarded. After that, in the first display-drive period (the time t4 to t5) and the second display-drive period (from the time t6) of the next frame, the in-panel gate control circuits work in the same way as in the above-described first display-drive period (the time t0 to t1) and the second display-drive period (the time t2 to t3).

FIG. 18 is a timing diagram for explaining a display action according to the fourth embodiment.

The display device has, in a one-frame period, a first display-drive period (the time t0 to t1), a second display-drive period (the time t2 to t3), a blank period (the time t1 to t2) and a flyback period (the time t3 to t4). The display-drive period from the time t4 to t5 is for display of the subsequent frame. In the blank period (the time t1 to t2) and the flyback period (the time t3 to t4), the touch-state-detecting action may be performed. In the first display-drive period (the time t0 to t1), the lines numbered 1 to 1022 are driven for display in pairs of lines with a 4-line cycle. In the second display-drive period (the time t2 to t3), the lines numbered 3 to 1024 are driven for display in pairs of lines with the 4-line cycle.

According to the action described above, the 1024 lines in one frame are evenly distributed to the two display-drive periods in pairs of lines with the 4-line cycle, and are driven for display. In this way, it becomes possible to provide a semiconductor device having a display-drive circuit for activating a display panel which is arranged so as to make the boundaries between regions produced by the difference in brightness resulting from time-division display harder to visually recognize and to prevent the degradation of display image quality which would result from time-division display. In this case, the number of lines forming a unit of the distribution (two lines) is designed to be equal to the number of lines forming a unit of data compression of an image and as such, no waste is caused in terms of the action of the decompression circuit 34.

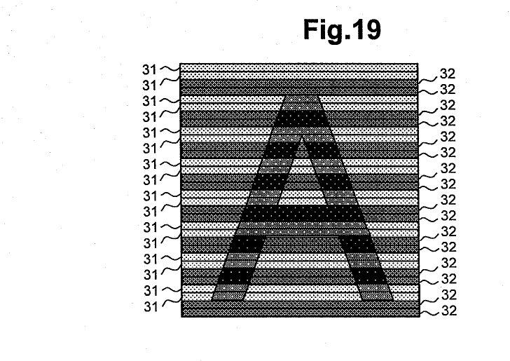

FIG. 19 is an explanatory diagram showing an example of image display by the time-division action of the display device according to the fourth embodiment. As drawn in FIG. 14, FIG. 19 shows an image displayed by one frame, and a part of the image having higher brightness is hatched in a deeper color. In the example of image display according to the fourth embodiment, regions 31 driven for display in the first display-drive period and regions 32 driven for display in the second display-drive period are evenly distributed in pairs of lines. It is apparent from the comparison to the image simply divided in two shown by FIG. 13 that the boundary lines of the regions 31 and 32 are harder to visually recognize with the human eye. Further, in comparison to the example shown in FIG. 14 in which the lines are distributed in lines, the region 31 driven for display in the first display-drive period and the region 32 driven for display in the second display-drive period have large areas respectively and therefore, the boundary lines of the regions are easier to visually recognize. Even so, the areas of these regions can be designed to be at or under the level that they can be visually recognized with the human eye as for a small display device with high resolution.

While the invention made by the inventor has been concretely described above based on the embodiments, the invention is not limited to the embodiments. It is obvious that various changes and modifications may be made without departing from the subject matter thereof. For instance, the explanations on the circuit embodiments and timing diagrams have been made taking positive logic circuits as examples, although negative logic circuits may be adopted instead of them.

What is claimed is:

1. A semiconductor device comprising:
a display-drive circuit operable to output drive signals for activating a display panel operable to display image data of each frame made up of a plurality of lines each composed of pixels,
wherein the display panel has, in each pixel of pixels constituting the lines, a capacitor for holding an electric charge corresponding to the image data in quantity,
the display-drive circuit is capable of performing a time-division action arranged so that a first display-drive period, a first blank period, and a second display-drive period are included in one frame period in turn, and
the display-drive circuit is arranged to be able to output the drive signals for: driving, in the first display-drive period, lines of the display panel in one frame which are distributed with a predetermined cycle; stopping activating the display panel in the first blank period; and driving, in the second display-drive period, lines of the display panel different from the lines driven for display in the first display-drive period in the one frame.

2. The semiconductor device according to claim 1, further comprising:
a touch panel controller operable to sense a touch state of a touch panel layered on the display panel,
wherein the touch panel controller performs a touch-state-sensing action for sensing the touch state in the first blank period, and stops the touch-state-sensing action in the first and second display-drive periods.

3. The semiconductor device according to claim 1, wherein the display-drive circuit is arranged to be able to output the drive signals for: driving, in the first display-drive period, lines of the display panel distributed in groups of N lines (N is an integer equal to or larger than one) with an M-line cycle (M is an integer equal to or larger than one) in one frame; and driving, in the second display-drive period, lines of the display panel different from the lines driven for display in the first display-drive period in the one frame, and distributed in groups of N lines with the M-line cycle in the one frame.

4. The semiconductor device according to claim 3, wherein the display-drive circuit is arranged to be able to output the drive signals for: driving, in the first display-drive period, lines of the display panel distributed in lines with the M-line cycle in one frame; and driving, in the second display-drive period, lines of the display panel different from the lines driven for display in the first display-drive period in the one frame, and distributed in lines with the M-line cycle in the frame.

5. The semiconductor device according to claim 4, wherein the display-drive circuit is arranged to be able to output the drive signals for: driving, in the first display-drive period, lines of the display panel distributed in lines with a 2-line cycle in one frame; and driving, in the second display-drive period, other lines different from the lines driven for display in the first display-drive period in the one frame.

6. The semiconductor device according to claim 3, wherein the display-drive circuit is arranged to be able to output the drive signals for: driving, in a first display-drive period of a first frame, lines of the display panel distributed in groups of N lines (N is an integer equal to or larger than one) with an M-line cycle (M is an integer equal to or larger than one) in the first frame; driving, in a second display-drive period of the first frame, lines of the display panel different from the lines driven for display in the first display-drive period, and distributed in groups of N lines with the M-line cycle in the first frame; and driving, in a first display-drive period of a second frame subsequent to the first frame, lines of the display panel different from the lines driven for display in the first display-drive period of the first frame, and distributed in groups of N lines with the M-line cycle in the second frame.

7. The semiconductor device according to claim 6, wherein the display-drive circuit is arranged to be able to output the drive signals for: driving odd-numbered lines in the first frame in a first display-drive period of a first frame; driving even-numbered lines in the first frame in a second display-drive period of the first frame; driving even-numbered lines in a second frame subsequent to the first frame in a first display-drive period of the second frame; and driving odd-numbered lines in the second frame in a second display-drive period of the second frame.

8. The semiconductor device according to claim 1, wherein the display-drive circuit includes a memory and a control part,
the control part writes, into the memory, image data which are input in an order of lines of a frame to be displayed going through a sequential scan from its top line, reads out, in the first display-drive period, image data of lines to be displayed in the first display-drive period from the memory in an order to drive the lines for display in, and reads out, in the second display-drive period, image data of lines to be displayed in the second display-drive period from the memory, and
the display-drive circuit produces the drive signals based on the read image data.

9. The semiconductor device according to claim 2, wherein the display-drive circuit includes a memory and a control part,
the control part writes, into the memory, image data which are input in an order of lines of a frame to be displayed going through a sequential scan from its top line, reads out, in the first display-drive period, image data of lines to be displayed in the first display-drive period from the memory in an order to drive the lines for display in, and reads out, in the second display-drive period, image data of lines to be displayed in the second display-drive period from the memory,
the display-drive circuit produces the drive signals based on the read image data,
the control part outputs timing signals to the touch panel controller, and
the touch panel controller controls start and stop of the touch-state-sensing action in the first blank period and the first and second display-drive periods based on the timing signals.

10. The semiconductor device according to claim 2, wherein the display-drive circuit and the touch panel controller are integrated together on a semiconductor substrate.

11. The semiconductor device according to claim 8, wherein the display-drive circuit further includes a compression circuit and a decompression circuit,
the control part causes the compression circuit to perform data compression of image data which are input in an order of lines of a frame to be displayed going through a sequential scan from its top line, and then writes the compressed data into the memory, reads out, in the first display-drive period, compressed data including image data of lines to be displayed in the first display-drive period from the memory in an order to drive the lines for display in, and reads out, in the second display-drive period, compressed data including image data of lines to be displayed in the second display-drive period from the memory,
the decompression circuit restores image data of the lines to be displayed by decompressing the compressed data read out from the memory, and
the display-drive circuit produces the drive signals based on the image data thus restored.

12. The semiconductor device according to claim 11, wherein the display-drive circuit is arranged to be able to output the drive signals for: driving, in the first display-drive period, lines of the display panel distributed in groups of N lines (N is an integer equal to or larger than one) with an M-line cycle (M is an integer equal to or larger than one) in one frame; and driving, in the second display-drive period, lines of the display panel different from the lines driven for display in the first display-drive period in the one frame, and distributed in groups of N lines with the M-line cycle in the one frame,
the compression circuit executes the data compression on image data in groups of N lines, and
the decompression circuit restores image data by decompressing data subjected to the data compression in groups of N lines.

13. A display device comprising:
a display panel operable to display image data of each frame made up of a plurality of lines; and
a display-drive circuit operable to output drive signals for activating the display panel,
wherein the display panel has, in each pixel of pixels constituting the lines, a capacitor for holding an electric charge corresponding to the image data in quantity,
the display-drive circuit is capable of performing a time-division action arranged so that a first display-drive period, a first blank period, and a second display-drive period are included in one frame period in turn, and
the display-drive circuit drives lines of the display panel distributed with a predetermined cycle in one frame in the first display-drive period,
stops activating the display panel in the first blank period, and
drives, in the second display-drive period, lines of the display panel different from the lines driven for display in the first display-drive period in the one frame.

14. The display device according to claim 13, further comprising:
a touch panel layered on the display panel; and
a touch panel controller operable to sense a touch state of the touch panel,
wherein the touch panel controller performs a touch-state-sensing action for sensing the touch state in the first blank period, and stops the touch-state-sensing action in the first and second display-drive periods.

15. The display device according to claim 13, wherein the display-drive circuit drives, in the first display-drive period, lines of the display panel distributed in groups of N lines (N is an integer equal to or larger than one) with an M-line cycle (M is an integer equal to or larger than one) in one frame, and drives, in the second display-drive period, lines of the display panel different from the lines driven for display in the first display-drive period in the one frame, and distributed in groups of N lines with the M-line cycle in the one frame.

16. The display device according to claim 15, wherein the display-drive circuit drives, in the first display-drive period, lines of the display panel distributed in lines with the M-line cycle in one frame, and drives, in the second display-drive period, lines of the display panel different from the lines driven for display in the first display-drive period in the one frame, and distributed in lines with the M-line cycle in the frame.

17. The display device according to claim 16, wherein the display-drive circuit drives, in the first display-drive period, lines of the display panel distributed in lines with a 2-line cycle in one frame, and drives, in the second display-drive period, other lines different from the lines driven for display in the first display-drive period in the one frame

18. The display device according to claim 15, wherein the display-drive circuit drives, in a first display-drive period of a first frame, lines of the display panel distributed in groups of N lines (N is an integer equal to or larger than one) with an M-line cycle (M is an integer equal to or larger than one) in the first frame, drives, in a second display-drive period of the first frame, lines of the display panel different from the lines driven for display in the first display-drive period, and distributed in groups of N lines with the M-line cycle in the first frame, and drives, in a first display-drive period of a second frame subsequent to the first frame, lines of the display panel different from the lines driven for display in the first display-drive period of the first frame, and distributed in groups of N lines with the M-line cycle in the second frame.

19. The display device according to claim 18, wherein the display-drive circuit drives odd-numbered lines in the first frame in a first display-drive period of a first frame, drives even-numbered lines in the first frame in a second display-drive period of the first frame, drives even-numbered lines in a second frame subsequent to the first frame in a first display-drive period of the second frame, and drives odd-numbered lines in the second frame in a second display-drive period of the second frame.

20. The display device according to claim 15, wherein the display-drive circuit supplies display panel with a flag indicating a line to be driven for display,
the display panel includes a shift register having a memory element provided for each group of N lines with the M-line cycle, and
the shift register accepts input of the flag, and is arranged so that the flag can be shifted by the line.

21. The display device according to claim 20, wherein the display panel has a pair of shift registers each having a memory element provided for each line with a 2-line cycle.

22. The display device according to claim 21, wherein the paired shift registers are disposed in regions sandwiching therebetween a display region of the display panel.

23. The display device according to claim 15, wherein the display-drive circuit includes a compression circuit, a memory, a decompression circuit, and a control part,
the control part causes the compression circuit to perform data compression of image data which are input in an order of lines of a frame to be displayed going through a sequential scan from its top line, and then writes the compressed data into the memory, reads out, in the first display-drive period, compressed data including image data of lines to be displayed in the first display-drive period from the memory in an order to drive the lines for display in, and reads out, in the second display-drive period, compressed data including image data of lines to be displayed in the second display-drive period from the memory,
the decompression circuit restores image data of the lines to be displayed by decompressing the compressed data read out from the memory, and
the display-drive circuit produces the drive signals based on the image data thus restored.

24. The display device according to claim 23, wherein the display-drive circuit is arranged to be able to output the drive signals for: driving, in the first display-drive period, lines of the display panel distributed in groups of N lines (N is an integer equal to or larger than one) with an M-line cycle (M is an integer equal to or larger than one) in one frame; and driving, in the second display-drive period, lines of the display panel different from the lines driven for display in the first display-drive period in the one frame, and distributed in groups of N lines with the M-line cycle in the one frame,
the compression circuit executes the compression on image data in groups of N lines, and
the decompression circuit restores image data by decompressing data subjected to the data compression in groups of N lines.

25. The display device according to claim 24, wherein the display-drive circuit supplies display panel with a flag indicating a line to be driven for display,
the display panel includes a shift register having a memory element provided for each group of N lines with the M-line cycle, and
the shift register accepts input of the flag, and is arranged so that the flag can be shifted by the lines.
